(19) United States
(12) Patent Application Publication
(10) Pub. No.: US 2003/0101124 A1
(43) Pub. Date: May 29, 2003

(54) Method and system for market based resource allocation

(76) Inventors: Nemo Semret, New York, NY (US); Giovanna Giammarino, New York, NY (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 09/854,325

(22) Filed: May 12, 2001

Related U.S. Application Data
(60) Provisional application No. 60/203,849, filed on May 12, 2000.

(51) Int. Cl. G06F 17/60

(52) U.S. Cl. 705/37

(57) ABSTRACT

The present invention provides a platform for resource allocation in real-time. One or more software resource agents interact with software player agents, which are one or more of buyers and seller agents, to reach an agreement on a price for a specific resource.

### RELATED APPLICATIONS

This application claims priority under 35 U.S.C. §119(e) to U.S. Provisional Application No. 60/203,849, filed May 12, 2000, which is herein incorporated by referenced in its entirety.

### BACKGROUND

A. Technical Field

This application relates to a system and method for real-time resource allocation and, specifically, to a system and method for allowing real-time buyers and sellers to bid for resources and controlling the applicable resources in accordance with the bids.

B. Background of the Invention

Over the past several years, the Internet has become an important mechanism for conducting business. It has helped reduce business cost and enabled the customized delivery of goods and services. To facilitate exchange of goods and services, electronic commerce technologies have been developed, ranging from simple Internet shopping sites to auction sites such as Yahoo (http://www.yahoo.com) and eBay (http://www.ebay.com).

At the same time, a small but growing market for telecommunication network bandwidth has developed. Bandwidth, however, is unlike traditional commodities, goods and services, in that: 1) it is a shared resource that cannot be stored. As such, any bandwidth capacity unused by one party can be made available to all other parties having access to it or it is lost. 2) The resource of bandwidth is consumed in real time. That is, it can occur simultaneously with the buying of the resource. 3) Demand for bandwidth fluctuates very rapidly and tends to be elastic.

Recently, the need for a dynamic bandwidth commodity market has been recognized. Bandwidth exchanges have been developed between new network companies and Internet service providers. The old system of signing lengthy contracts after weeks or months of negotiation does not move fast enough for buying and selling of many Internet-related resources, such as bandwidth.

The allocation of information service resources can be viewed as an exchange of commodities. In particular, in the case of bandwidth, Dow Jones has announced plans to launch a bandwidth index that will provide price for long-haul data routes and will enable companies to use these figures to peg the changing process for contracts when they are buying access to networks.

The emerging telecommunications market call for new mechanisms for real-time trading of network resources, such as bandwidth. In a convention human-based resource trading system, resources for sale are posted, such as on a bulletin board or similar online location. Human beings peruse the posted resources and try to decide which resources their organizations will need in the future. The humans then place bids against each other for the resources. Such human-based resource trading systems usually operate on large amounts of bandwidth at a time and trades are performed periodically, the period being fairly long due to the limits of human attention span and speed. For example, it would be impractical for a human-base trading system to buy and sell resources in one minute or five minute partitions, since human beings are not capable of such speed. In addition, most human-based resource agents rely on additional human interaction to implement the results of the resource bidding.

### SUMMARY OF EMBODIMENTS OF THE INVENTION

The present invention provides a platform for resource allocation in real-time. One or more software resource agents interact with software player agents, which are usually both s and seller agents, to reach an agreement on price and quantity allocations for each buyer of that resource (for example, X Mbs of bandwidth for Y units of time, at price Z for buyer A). The s operate in accordance with one or more strategy rules for that agent. A strategy rule tells the what strategy to use in bidding against other agents for particular resources. The s also operate in accordance with valuation rules that tell the how to value a particular resource when bidding (this value is often used as a part of the strategy rule). Seller agents also contain their own strategy and valuation rules, which allow them to decide how much of a resource to offer and how to set a minimum price for the resource. Both player agents (buyer and sellers) and resource agents are aware of a global allocation rule used by the resource agent to allocate a resource between the buyers. In the buyer and seller agents, this allocation rule is often considered in determining strategy.

In the described embodiment, player agents (buyer and seller) also contain a graphical user interface that allows human beings to set their rules and to control various aspects of the player agent.

In general, the present invention promotes the sharing of a limited resource, such as bandwidth, buffer space, memory space, storage, or processor time, in a competitive environment. This environment ensures that whomever need the most resource and has the ability to pay will get a share of the resource in accordance with willingness to pay, in addition, the invention adjusts for the changing needs of the participants over time.

Advantages of the invention will be set forth in part in the description which follows and in part will be apparent from the description or may be learned by practice of the invention. The objects and advantages of the invention will be realized and attained by means of the elements and combinations particularly pointed out in the appended claims and equivalents.

### BRIEF DESCRIPTION OF THE DRAWINGS

FIG. 1 is a block diagram of an embodiment of the present invention.

FIG. 2 is a flow chart of a method performed by a resource agent of FIG. 1.

FIG. 3 is a flow chart of a method performed by a of FIG. 1.

FIG. 4 is a flow chart of a method performed by a seller agent of FIG. 1.

FIG. 5 is a chart showing an example of the result of an allocation rule.

FIGS. 6(a) and 6(b) show an example of a valuation rule.

FIGS. 7(a) and 7(b) show an example of a strategy rule.

FIG. 8 shows an example of a flow chart used by an accounting system of an embodiment of the invention.

FIG. 9(a) is a more detailed block diagram of the embodiment of FIG. 1.

FIG. 9(b) shows an example of how a bandwidth resource is given to the winning bidder.

FIG. 10 shows an example of an embodiment of the present invention including a “garage” for player agents.

FIGS. 11(a)-11(b) are an example of an XML file for a generic player agent.

FIGS. 12(a)-12(c) shown an example of Java code implementing a strategy rule for a.

FIGS. 13(a)-13(c) show an example of Java code implementing an allocation rule for a resource agent 104.

FIG. 14 is an example of an XML file for a generic resource agent.

FIGS. 15(a)-15(r) show examples of user interfaces for buyer and seller agents.

### DETAILED DESCRIPTION OF EMBODIMENTS

Reference will now be made in detail to several embodiments of the present invention, examples of which are illustrated in the accompanying drawings. Wherever practicable, the same reference numbers will be used throughout the drawings to refer to the same or like parts.

The present invention uses distributed, self-optimizing software agents to perform resource allocation more efficiently than centralized or human-based systems.

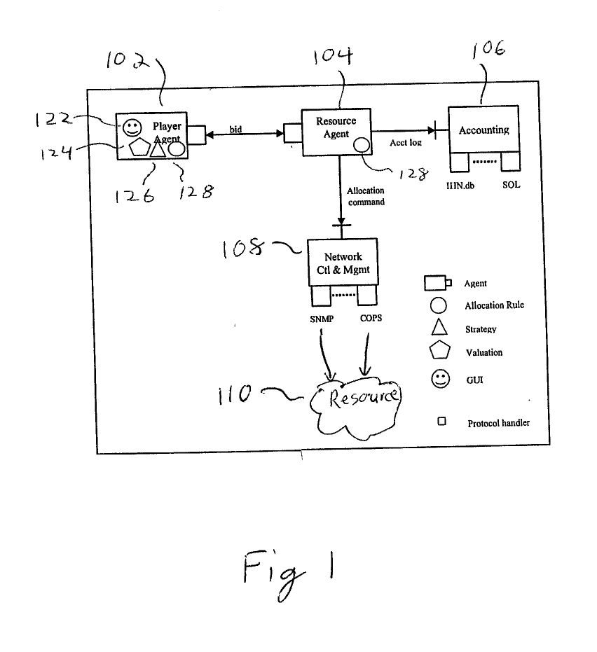

FIG. 1 is a block diagram of an embodiment of the present invention. FIG. 1 includes a software player agent 102, which represents multiple and seller agents. A typical system will, include both buyer and seller agents 102. FIG. 1 also includes a software resource agent 104, a software accounting agent 106, a network control and management agent 108 and a resource 110. It is contemplated that resource 110 can be a number of different resources, including but not limited to: bandwidth, buffer space, memory space, storage, or processor time. As shown in FIG. 1, each player agent (buyer and seller agent) can contain a Graphical User Interface (GUI) 122, one or more valuation rules 124, one or more strategy rules 126, and one or more allocation rules 128. The resource agent 104 also contains the same one or more allocation rules 128.

s 102 place bids to the resource agent 104, which ultimately decides which of the player agents is awarded a portion of each resource for a predetermined amount of time.

Resource agent 104 also controls resource 110, based on the results of the bidding, by sending an allocation command to network control and management agent 108. Thus, for example, if the resource is Internet bandwidth, if buyer A has won X Mbs of bandwidth for 5 minutes, resource agent 104 directs the network control and management agent 108 to give precedence to packets originating at buyer A for the next five minutes or to ensure that the agreed upon bandwidth requirements are met for buyer A's packets for the next five minutes. The mechanism used to communicate the allocation command from resource agent 104 to agent 108 can be any appropriate mechanism. In the example shown, the allocation command will include an identification of the winning buyer or buyers and an identification of the amount of resource allocated and the time period for which it is allocated. Other appropriate formats can be used without departing from the spirit of the invention. In some embodiments, agents 104 and 108 are separate agents (as shown in the figure). In other embodiments, their functions are merged into a single agent. Agents 104 and 108 can be owned and/or controlled by the same entity or by different entities. For example the owner of resource 110 could outsource the market-based allocation to a business partner operating resource agent 104, while keeping the network management and control function in its own hands, by retaining operation of the network control and management agent 108 themselves.

In the embodiment shown, network control and management agent 108 controls resource 110 to implement the allocation command received from resource agent 104. Thus, agent 108 commits the resource allocated to a player after the resource agent 104 has closed the bidding. Network control and management agent 108 provides a common interface for resource agent 104 for all systems supported. In certain embodiments, there is one agent 108 per resource. Alternately, a single agent can control multiple resources and communicate with multiple resource agents 104. In the embodiment shown, network management and control agent 108 controls resources belonging to other entities (i.e., not to the owner of resource agent 104). In other embodiments, resource 110 might also be under the direct control of the owner of resource agent 104.

FIG. 1 shows that network control and management agent 108 sends either Simple Network Management Protocol (SNMP) commands or COPS (Common Open Policy Service Protocol) commands to the resource. The SNMP protocol is well known and is described in RFC 1089, RFC 1270, RFC 1303, RFC 1298, RFC 1418, and RFC 1419, which are incorporated herein by reference in their entirety. The COPS protocol is well known and is described in “The COPS (Common Open Policy Service,” dated Mar. 5, 1999, available from Adobe Systems, Inc. of San Jose, Calif., and RFC 2748., both of which are incorporated herein by reference in their entirety. Other appropriate resource control protocols can be used without departing from the spirit of the invention.

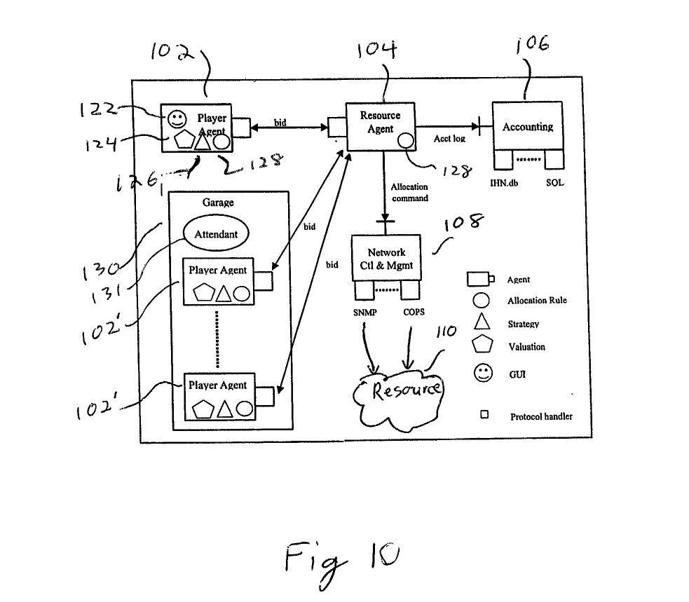

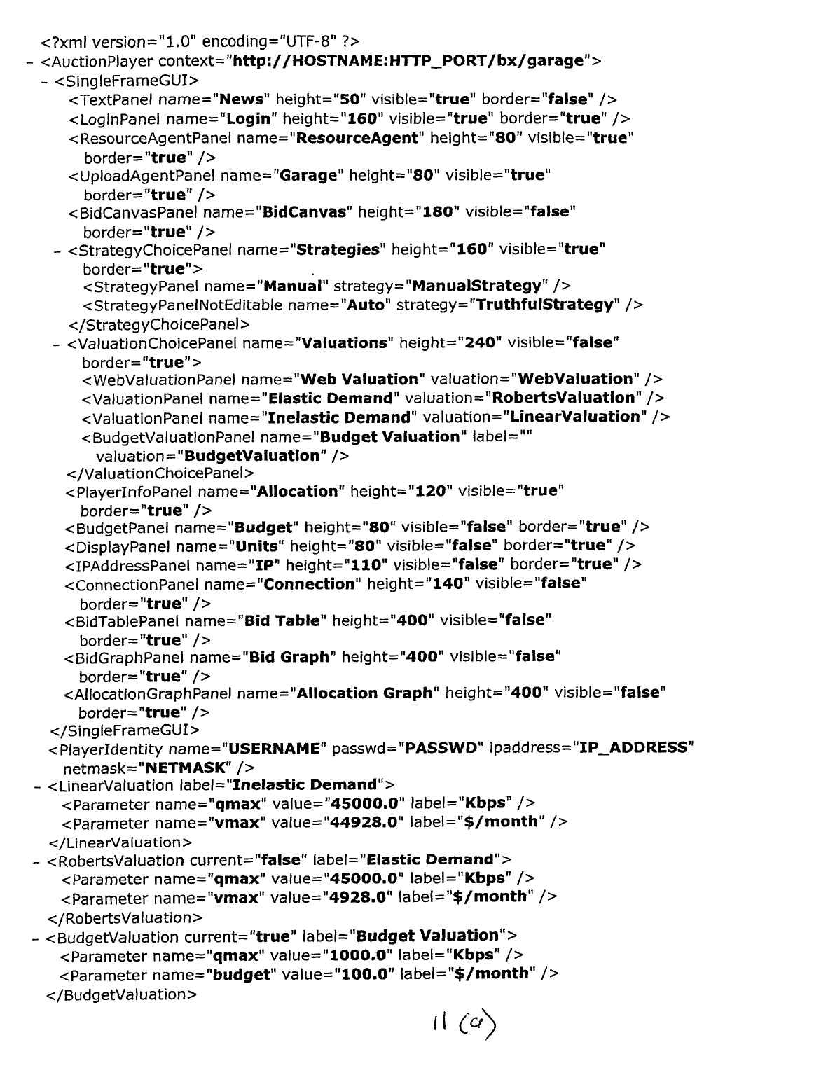

Once one or more winning buyers are determined, resource agent 104 alerts accounting agent 106, which keeps track of the winning buyers, as described below in connection with FIG. 9(a). Accounting agent 106 provides a common interface for all accounting systems supported. Agent 106 preferably contains a database handler for each system it supports. Although accounting agent 106is shown as using one or more of the IHN and SQL database interfaces, any appropriate interface to an accounting database could be used.

The 102 operates in accordance with one or more strategy rules for that agent. A strategy rule tells the what strategy to use in bidding against other agents for particular resources and, therefore constitutes a bidding mechanism for agents.

The s also operate in accordance with valuation rules that tell the how to value a particular resource when bidding (this value is often used as a part of the strategy rule). Thus, a valuation rule typically tells an agent how to value each unit of a resource over a range of possible quantities, at a given time. Seller agents also contain their own strategy and valuation rules, which allow them to decide how much of a resource to offer and how to determine a minimum price for the resource. Strategy and valuation can depend on external information, such as accounting information and network congestion.

The valuation and strategy of player agents (buyer and sellers) and resource agents are aware of a global allocation rule used by the resource agent to allocate a resource between the buyers. In the buyer and seller agents, this allocation rule is often considered in determining valuation and/or strategy. Thus, an allocation rule typically can be thought of as corresponding to a market mechanism. Examples of allocation rules include English auctions (familiar to persons who frequent human-based antique and estate sale auctions), Reverse Price Auctions (such as the main eBay model), Dutch auctions, and continuous bid-ask trading. Examples of allocation rules are found, for example, in 1) J. F. Rosenschein and G. Zlotkin, “Rules of Encounter,” MIT Press 1994; 2) PhD thesis of N. Semret, “Market Mechanisms for Network Resource Sharing,” Dept. of Electrical Engineering, Columbia University, submitted approximately May 1999; and 3) H. R. Varian, “Economic Mechanism Design for Computerized Agents,” USENIX Workshop on Electronic Commerce, July 1995. Each of these three references is incorporated herein in its entirety.

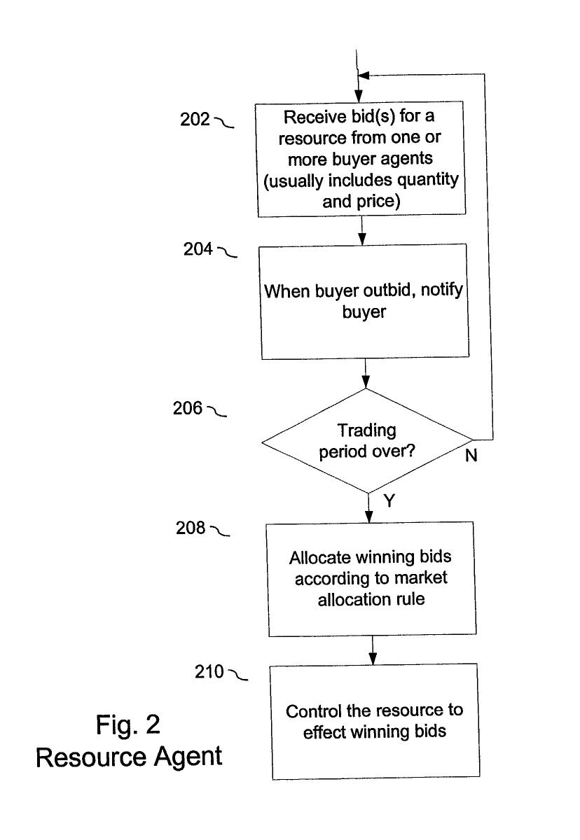

FIG. 2 is a flow chart of a method performed by resource agent 104 of FIG. 1. In at least certain embodiments, there is more than one resource agent—one for each resource. For example, if an ISP offers several different bandwidths, each bandwidth might be considered a separate resource, controlled by a separate resource agent 104. Resource agents preferably run within servers that can be distributed over a network. Alternately, one or more resource managers 104 can reside on the same system.

As shown in FIG. 2, resource agent 104 receives 202 one or more bids for resource 110 from one or more s 102. Such bids will usually include at least quantity and price values. If a buyer is outbid, the resource agent notifies 204 the buyer, unless the trading period is over 206. Once the trading period is over, the resource agent notifies 208 the winning or agents and proceeds to send an allocation command 210 to network control and management agent 108 that will cause agent 108 to control the resource in accordance with the winning bids.

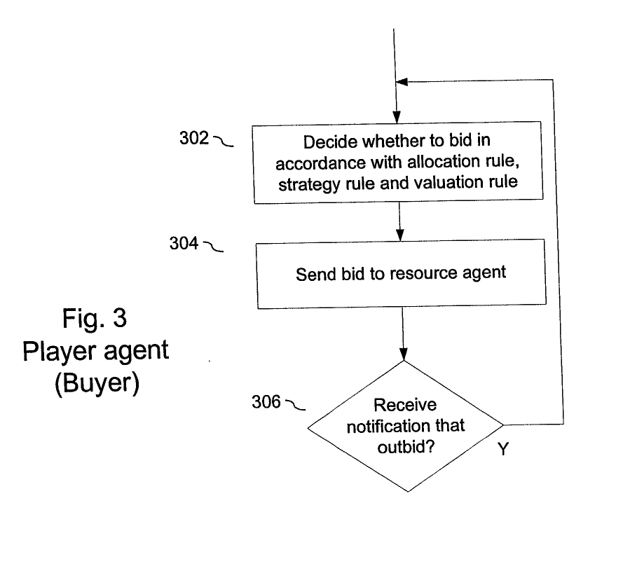

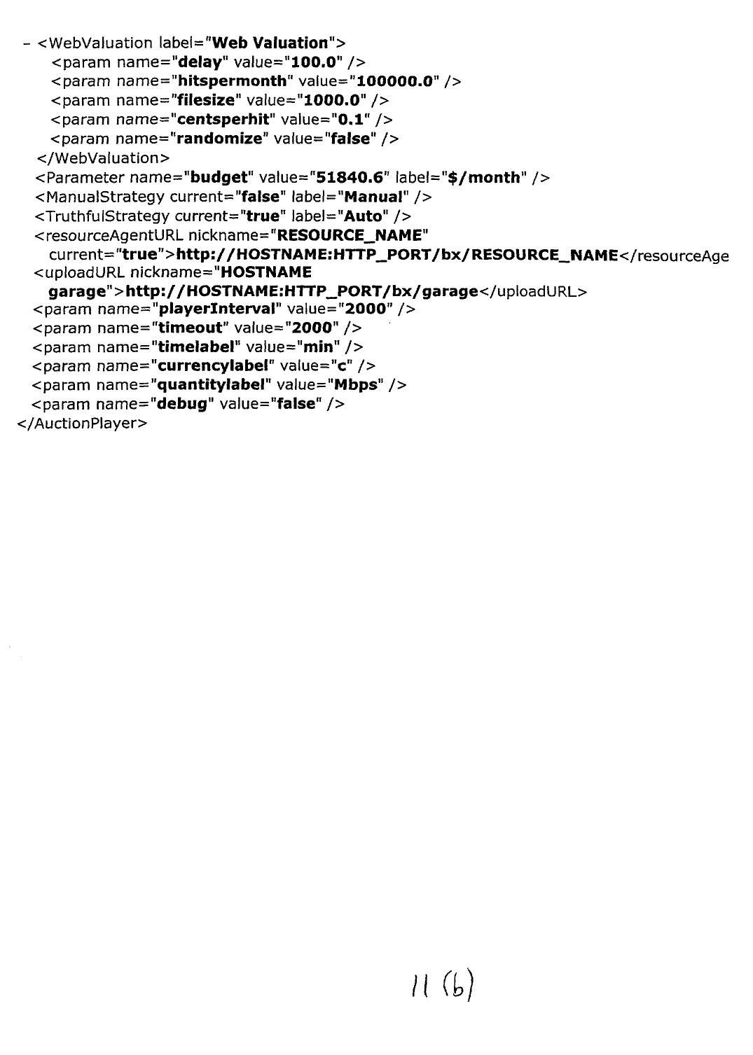

FIG. 3 is a flow chart of a method performed by player/buyer 102 agent of FIG. 1. First, the is apprised of potential resources available for bidding. This is accomplished either by the player requesting current resource auction information from a centralized directory service (not shown) or by the player registering with the resource agent and periodically being sent information about current bidding. With a directory service, a player agent 102 queries the directory service to find the location (e.g., in the form of a URL) of resource agents 104, garages (see FIG. 10), and other player agents 102. The decides 302 whether to bid on a particular unit or resource 110 and sends 304 a bid to the resource agent. If the receives a notice that he has been outbid, control returns to element 302 and the agent decides whether to continue bidding.

In element 302, the uses its knowledge of the system market allocation rule and of its own valuation rules to determine how much it is willing to pay for resources at a given time and uses its own strategy rules to determine whether to bid on available resources. If the includes a GUI, a human being can visualize the market using various known graphs, charts or similar graphics. A user can also use the GUI to change the strategy and valuation rules used by the agent.

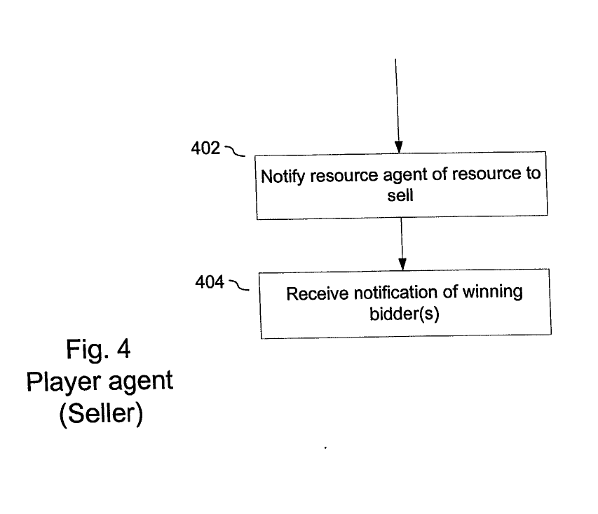

It should be noted that certain embodiments include a special type of player/, called a broker agent, which buys resources with the intent of reselling those resources.. Thus, for example, a broker agent has no user for the resource (such as bandwidth) itself, since the broker is not an ISP or similar entity in need of bandwidth. Instead, the broker arranges for third party customers, such as ISPs, to receive the benefit of the resources the broker has bid for and won, by reselling them through another resource agent instance, and the broker keeps the difference between the buying and selling price.. In such a case, the new resource agent 104 informs the network control and management agent 108 which party is to benefit from the resource bid for by the broker. FIG. 4 is a flow chart of a method performed by a player/seller 102 agent of FIG. 1. A seller agent first notifies 402 the resource agent that it has one or more units of a resource to sell (for example, 1 Mbs for 5 minutes or 10 minutes of processor time). Once the bidding is over, seller agent 102 will receive from resource agent 104 a notification 404 of the winning bidder or bidders. In at least one embodiment, the seller agents collect the payments from the buyers based on accounting information retrieved from the accounting agent. 106.

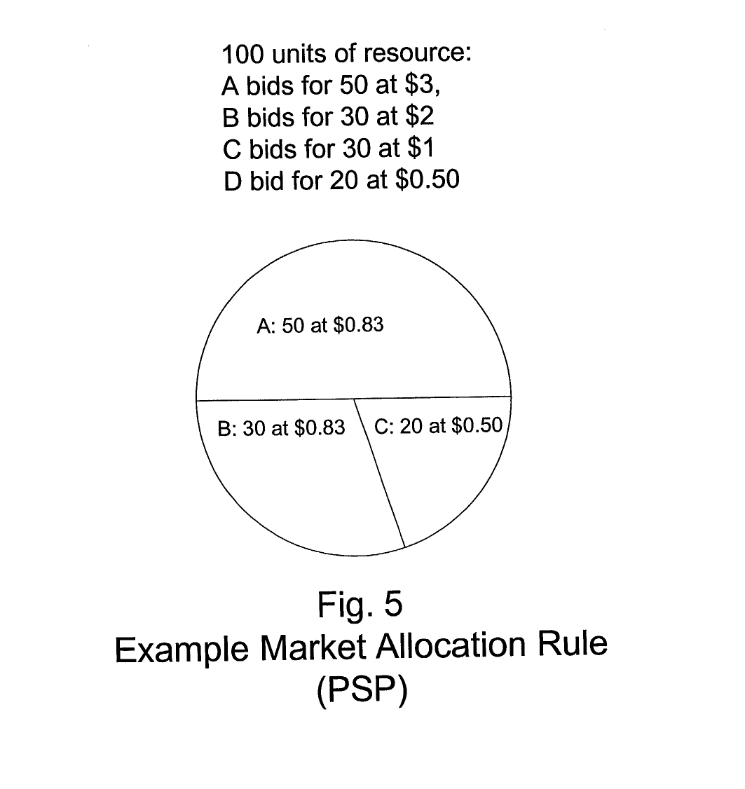

FIG. 5 is a chart showing an example of the result of a Progressive Second Price Auction (PSP) allocation rule. Other allocation rule types, as discussed above, can also be used, as specified by the particular allocation market strategy implemented in a particular system. FIG. 5 shows how resources are allocated and prices set once the bidding is over and it is determined that there are not enough resources to satisfy all the bidders.

In the PSP auction of FIG. 5, bidder A bids $3 for 50 resource units; bidder B bids $2 for 30 resource units; bidder C bids $1 for 30 resource units; and bidder D bids $0.50 for 20 resource units. At the close of bidding, resource agent 104 allocates the resources as follows: The 100 available resource units are apportioned between the bidders until the resource is gone. Thus, the high bidder A is allocated all of the resource that he wants, as is the second high bidder B. Bidder C only gets 20 or the 30 resource units that he wanted and bidder D gets nothing, since there are no more resource units to allocate after partially fulfilling bidder C's wants.

The resource agent 104 determines the amount that the bidders in the PSP auction are charged as follows: For each bidder, the resource agent determines the value of the bidder's resource if that bidder had not participated, and charges the bidder a price based on this determination.

Thus, if bidder A had not participated, his 50 units would have been allocated as follows:

10 units to bidder C (to make up C's shortfall)

20 units to bidder D (to give D his requested number of units)

The remaining 20 of bidder A's units would not have been allocated.

The cost to bidder A is determined as follows:

The cost of a resource unit to bidder C is $1/30.

Thus, the value that would have been given to bidder C: 10×($1/30)=$0.33

The cost of a resource unit to bidder D is $0.50/20.

Thus, the value that would have been given to bidder D: 20×($0.50/20)=$0.50

Thus, the cost of A's resources had A not participated is $0.33+$0.50=$0.83. Bidder A is charged this amount for his 50 units of resource.

Similarly, if bidder B were not present, his 30 units would have been allocated as follows:

10 units to bidder C (to make up C's shortfall)

20 units to bidder D (to give D his requested number of units)

The cost to bidder B is determined as follows:

The cost of a resource unit to bidder C is $1/30.

Thus, the value that would have been given to bidder C: 10×($1/30)=$0.33

The cost of a resource unit to bidder D is $0.50/20.

Thus, the value that would have been given to bidder D: 20×($0.50/20)=$0.50

Thus, the cost of B's resources had B not participated is $0.33+$0.50=$0.83. Bidder B is charged this amount for his 30 units of resource.

Similarly, if bidder C were not present, his 20 units would have been allocated as follows:

20 units to bidder D (to give D his requested number of units)

The cost to bidder C is determined as follows:

Value that would have been given to bidder D: 20×($0.50/20)=$0.50

Thus, the cost of C's resources had C not participated is $0.50. Bidder C is charged this amount for his 20 units of resource.

It should be noted that FIG. 5 shows only how resources are allocated after bidding is closed. An allocation rule also includes within it rules or explanations of how the auction itself should be conducted. For example, a PSP auction generally lasts for a predetermined amount of time (for example, five minutes). While the bidding is open, resource agent 104 collects all bids received from the s 102 and saves them in a bidlist data structure (e.g., a linked list). The bidlist data structure indicates which bid is the most recent bid for each 102.

As bids are received from the s 102 by the resource agent 104, the resource agent 104 transmits the bids received to the other agents 102, so that all agents know what all other participating agents are bidding. Because each 102 has knowledge of the allocation method, each 102 can apply its strategy and valuation rules to determine whether that agent is going to be allocated the resources on which it has bid. The agent, applying the allocation, strategy, and valuation rules, determines whether it should bid again. In a PSP auction, bidding usually stabilizes after a few minutes. In some embodiments, resource agent 104 does not hold the auction open for a predetermined time, but instead waits a predetermined amount of time after the bidding has stabilized to make sure that no other bids are received. In some cases, resource agent 104 announces to the s 102 that bidding will close in a certain number of minutes or seconds. In some cases, if a bid is received during this time period, the auction is kept open a bit longer.

Thus, an allocation rule (known to all agents) also includes information about how the auction will be conducted by resource agent 104, including, for example: how long an auction will last, if the auction has no set time period, what are the conditions for the auction to close. In addition, as described above, the allocation rule includes rules describing how price and quantities are assigned after the auction has closed.

In a preferred embodiment of the invention, auctions last 5 minutes, although other periods of time could be used and these periods of time could be either variable or user-settable. In a preferred embodiment, the bandwidth resource being auctioned during a current auction is allocated immediately and another auction is begun immediately. Thus, an auction occurs roughly every five minutes for the bandwidth that will be used by the buyers during the next five minutes. Other embodiments may not auction all bandwidth for immediate use.

The PSP auction model is described further in A. A. Lazar and N. Semret, “Design and Analysis of the Progressive Second Price Auction for Network Bandwidth Sharing,” Telecommunications Systems, Special issue on Network Economics, which is attached hereto as Appendix A and forms a part of this application.

Other examples of allocation rules include, but are not limited to a Hold Option Auctions, which are discussed, for example, in the PhD thesis of N. Semret, “Market Mechanisms for Network Resource Sharing,” Dept. of Electrical Engineering, Columbia University, submitted approximately May 1999, Chapter 4 of which (28 pages) is attached hereto as Appendix B and which forms a part of this specification. The Hold Option is a concept for advance price and quantity guaranteed reservations of network resources in a real-time market environment. Periodic auctions (progressive second price, or other) among arrivals grouped in batches give rise to the spot market of capacity changes. A reservation guaranteeing access for an arbitrary duration with a capacity piece below the bid can be made at any time before or during service. This eliminates the risk (which is inherent on the spot market) of losing resources to higher bidders before service completion. The reservation is defined as a hold option, and is analogous to derivative financial instruments such as options and futures integrated over time. Based on a heavy traffic diffusion model, reservation fees can be computed as the fair market price of a hold option. In at least one embodiment, special player agents 102 are allowed to place such hold options, thus providing a guaranteed reservation of a network resource for an arbitrary duration.

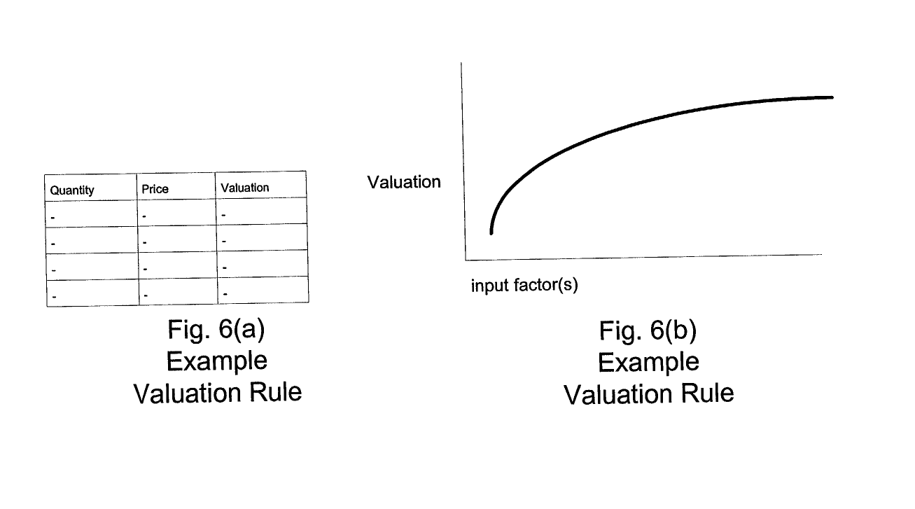

FIGS. 6(a) and 6(b) show examples of valuation rules. In FIG. 6(a), a valuation rule is formed of pairs of quantity/price values. In FIG. 6(b), a valuation rule is formed as a function of various input variables. These input variables can include any or (but are not limited to): the number of hits on a web site the average file size downloaded (and the bandwidth needed to service those files); the expected delay or expected latency, and the value of each hit. Valuation can also be time dependent (e.g., higher valuations are assigned during peak usage times when more bandwidth is needed) and the network state (e.g., more bandwidth is needed if the network is congested).

It should be noted that there are engineering tradeoffs for the type of valuation rule used. Because a low-level valuation rule requires more inputs, which require more time and effort to collect and receive, a low-level description may require a large amount of data to be transferred in order for the agent to be able to bid in accordance with the low-level valuation rule. On the other hand, a simple, high-level valuation rule reduces the ability of an agent to make an optimum bid because the agent is operating with less information. Either implementation can be correct for a given circumstance, depending on the needs of the particular player agent and the limitations of its system and network.

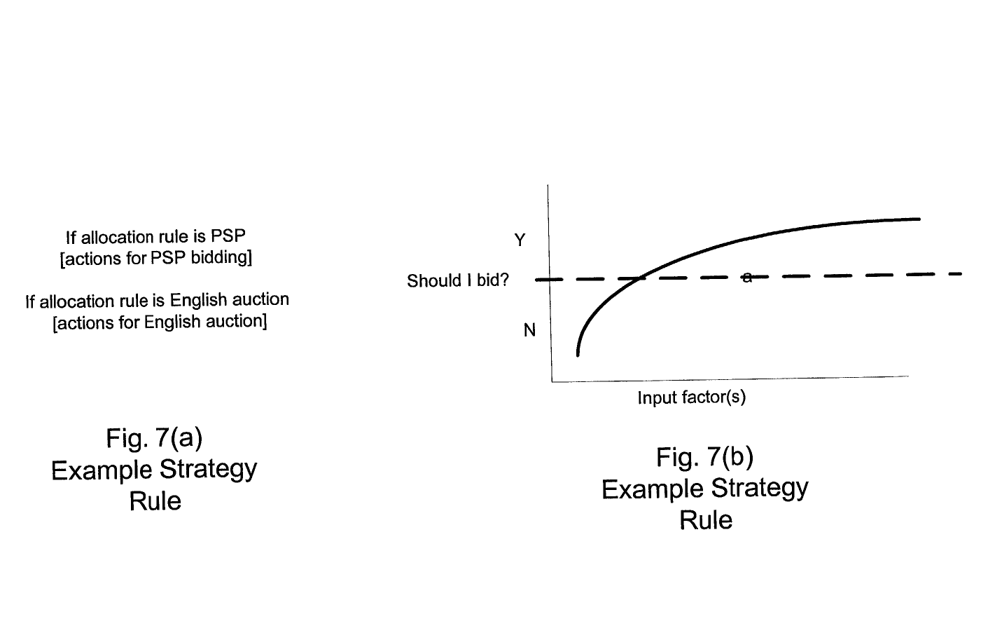

FIGS. 7(a) and 7(b) shows examples of strategy rules. FIG. 7(a) shows a simple rule set, where the first precedent is to identify the type of allocation system being used. Once the allocation system if identified, the 102 applies a set of predefined conventional rules to determine whether it should bid (or bid again). FIG. 7(b) shows an example where the strategy is based on a user-defined function. In the example, if the function reaches a threshold value, the agent 102 will bid (or bid again). Other examples of strategy rules decide not just whether the agent should bid, but how much the agent should bid, in accordance with the allocation rule being used by the system and in accordance with factors specific to that agent (such as, for example, those factors discussed above in relation to valuation rules).

Certain strategy rules are very simple and involve bidding constant amount. Such simple strategy rules may result in uneven amounts of bandwidth being won. Another example strategy rule is periodic bidding, in which a buyer agent enters auctions periodically.

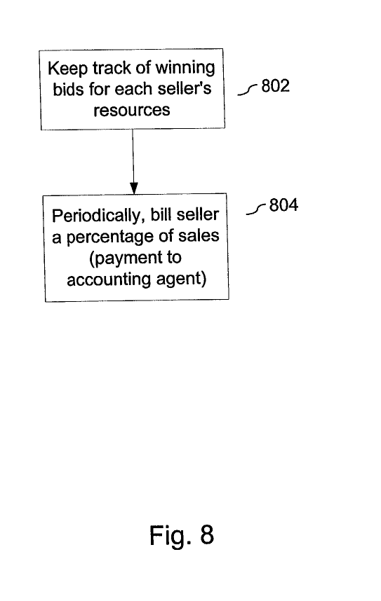

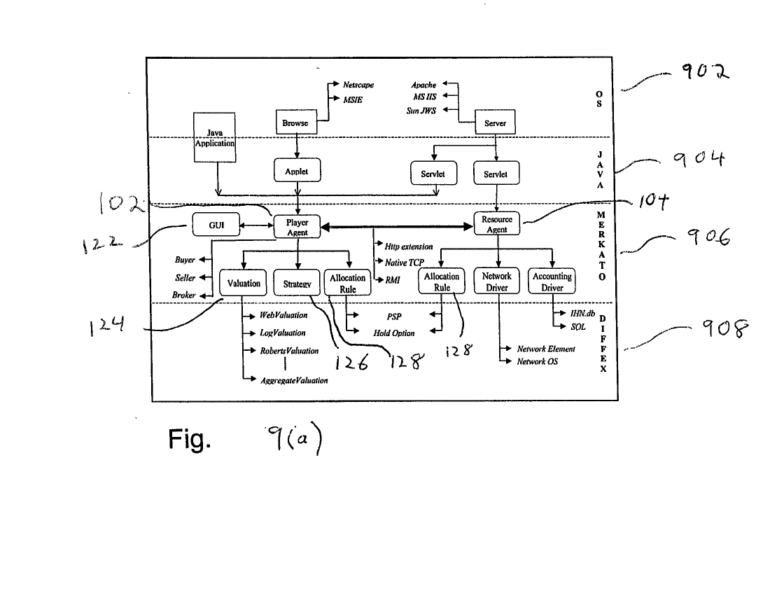

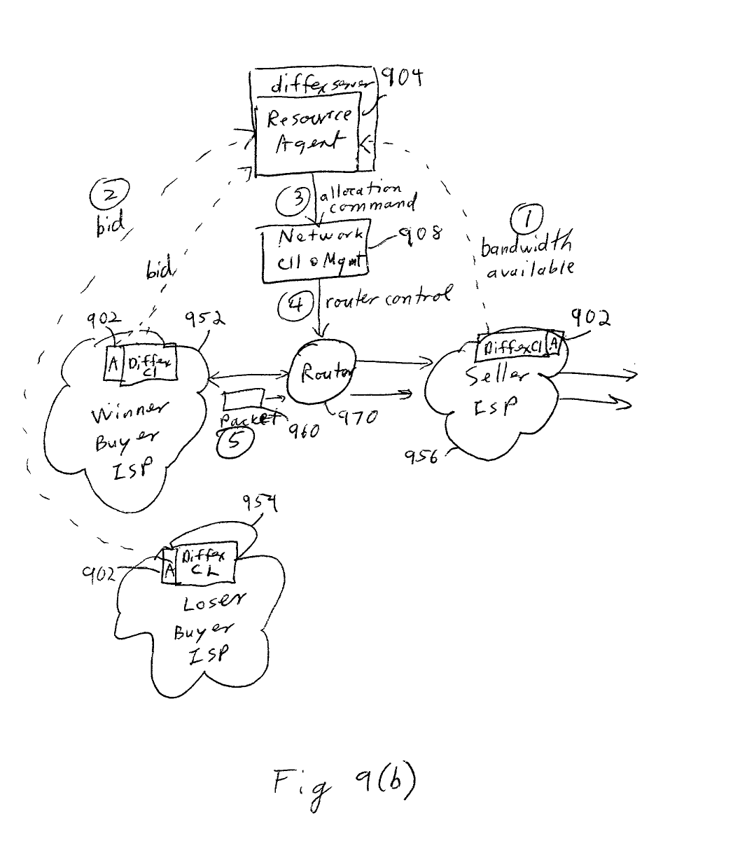

FIG. 8 shows an example of a flow chart used by an accounting system of an embodiment of the invention. The accounting system is notified whenever a resource agent closing bidding on a resource unit and keeps track 802 of the winning bids and resulting allocations. Periodically, the accounting system bills 804 the seller a percentage of the resources sold, which is received by the owner of the resource agent for operating the resource agent and account agents of the Merkato platform.

FIG. 9(a) is a more detailed block diagram of the embodiment of FIG. 1. It will be understood that FIG. 9(a) details only one possible way to implement the present invention and that the description herein is not to be taken in a limiting way with regard to operating systems, protocols, programming languages, etc. The example shown is implemented in Java using the World Wide Web, but the invention is not limited to such a system. In fact, the invention can be implemented on any appropriate computers and networks, using any appropriate programming language, hardware, software, and operating system. Parts of the system can be implemented in software, firmware, or hardware, as needed.

FIG. 9(a) includes four layers: an operating system (OS) layer 902, a Java layer 904, a Merkato layer 906, and a diffex layer 108. In the described embodiment, the OS layer 902 and the Java layer 904 are conventional and will not be described herein. Other embodiments may make changes to one or more of layers 902 and 904 to enhance the performance of the system, for example. In this example, the use of Java layer 904 makes the system platform independent. Thus, the Merkato layer 906 can run on any computer or computing device (such as a wireless device, pager, cell phone, or Internet appliance)

Layer 906 allows a player agent 102 to be executed on the client side, from a Java application or an applet executing in a Web browser. Alternately (or in addition), a player agent 102 can be executed as a servlet on a web server, which is the “garage” environment of FIG. 10.

Layer 908 enables real-time resource markets between peering ISPs. The layer 908 allows ISPs to buy and sell resources, such as bandwidth, from each other in real-time. Layer 908 auctions in real-time the outgoing bandwidth on each ISP's line out of the exchange, ensuing that at all times, the bandwidth goes to the buyer with the highest value for it. Layer 908 also allows for buying and selling in advance (i.e., making reservations with guaranteed capacity and capped prices) through a derivative market of options, in effect enabling the trading of risk and hedging, for original ISP buyers and sellers, as well as for purely financial players.

FIG. 9(b) shows and example of how a winning buyer ISP 952 is given a resource, such as bandwidth. In FIG. 9(b), a seller ISP 956 has a seller 902 agent running on a diffex client. As discussed above, the seller agent determines that the ISP has bandwidth to sell (e.g., through user input via the seller agent GUI) and makes that bandwidth available for auction by sending a message to resource agent 904 (see numeral 1 in a circle). The buyer ISPs 952, 954 have s 902 running on a diffex client. The s bid on the bandwidth in accordance with their allocation rules, strategy rules, and valuation rules, as discussed above (see numeral 2 in a circle). For certain types of allocation models, the agents also receive information about bids during the auction (not shown). Once the auction is concluded, resource agent 904 sends an allocation command to network control and management agent 908 (numeral 3 in a circle), which in turn controls a router 970 of the seller ISP so that the winning buyer ISP receives its bandwidth (see numeral 4 in a circle).

Resource agent 104 in layer 908 interfaces with the resource (e.g., with the router 970 of the seller ISP) to allocate the bandwidth to the winning bidder. Specifically, resource agent 904 interfaces with control agent 908 to send commands to the router of the seller ISPs. If, for example, the resource is bandwidth, allocation to the winning bidder can be effected by one of the following or by any other appropriate method:

a) the router 970 is given a set of class-based weighted-fair queuing parameters to be used by the router to control packet queuing in the router so that the winning ISP buyers are assured of receiving the bandwidth which they was allocated by the resource agent. These queuing parameters will give priority to the winning bidders when packets from the winning ISPs are sent to the seller ISP's router.

b) the router is given a set of committed access-rate parameters to be used by the router to limit and shape traffic assure each buyer the bandwidth which it is allocated, or

c) capacity within an MPLS (Multiprotocol Label Switching) tunnel between two points in the seller's network.

Thus, as shown in FIG. 9(b), packets 960 from the winning buyer ISP(s) are routed through the seller's router and on to the seller ISP's network 956, from which they are delivered to their destination. In at least one embodiment, the winning ISPs are aware that they have won and use existing routing protocols to ensure that they direct packet traffic to the seller ISP's router. In other embodiments, the resource agent informs routers in the winning ISPs of the needed routing change using known routing protocols.

In the described embodiment, the resource agent is always executed on a Web server. Each resource agent 104 runs as a servlet on a Web server. This architecture is scalable because resource agents 104 can be distributed to run on any Web servers supporting the concept of a servlet.

In the described embodiment, communications between a player agent (either a buyer or a seller) 102 and a resource agent 104 are performed via a resource agent proxy using any of http extensions, native TCP protocol, or Java's remote method invocation (rmi). All communications are secured through an appropriate mechanism such as the secured socket layer (SSL). A shown in FIG. 9(a), each agent (player and resource) has an allocation rule object 128. The player agents 102 also have valuation rule objects 124, strategy rule objects, 126, and a GUI object 122. In addition, the resource agents 104 have networking and accounting drivers for interfacing with external support systems. Further security is provided through the implementation of specific allocation rules that protect the stability of the system. Specifically, each user is required to pay a bid fee to resource agent 104 for every bid sent. The implementation of a bid fee is intended to prevent users from trying to artificially destabilize the resource price and to prevent a “man in the middle” attack, which is defined as a third party intercepting a bid from another agent and keeping sending the same bid over and over. In addition, timestamps are preferably used to discriminate every bid. Thus, if a bid has a previously used timestamp, resource agent 104 will ignore that bid.

In the described embodiment, communication between agents is effected using http, thus bypassing many problems associated with firewalls, proxies, and other middleware.

FIG. 10 shows an example of an embodiment of the present invention including a “garage” for player agents 102′. The garage 130 is a component on a web server that serves the purpose of storing agents and enabling their execution remotely from a user's computer. The garage contains an “attendant” program 131 whose job is to help mobile agents find a parking place in the garage and to ensure proper agent execution when the agents want to run autonomously. Garage 130 performs the function of a distributed database to store the agents 102′ and provides a distributed processor (not shown) to execute the agents. Garage 130 can be located on the same system as resource agent 104, but can also be located on a different machine.

The attendant is an example of a multi-agent. Multi agents coordinate multiple simple agents to act together. Multi-agents can be used to form coalitions of agents, using the attendant to bid for aggregated resources on behalf of the coalition. In the described embodiment, the agents communicate with the attendant to let the attendant know that they need resources. The multi-agent aggregates the various types of resources requested (e.g., different connection speeds or different bandwidths) and uses the allocation rule and its own strategy and valuation rules to bid on behalf of the agents. If the multi-agent wins, the resource is divided between the agents and the attendant so informs the resource agent 104, which allocates the bandwidth accordingly. A broker is an example of a multiagent, coordinating buyer and seller agents for a common objective to act as a profit-maximizing reseller.

In the described embodiment, agent mobility to the garage is provided through XML. The syntax and semantics of an agent is described using XML. For example, the semantics of an agent can include its allocation, strategy and valuation rules. Each agent can be transferred to the “garage” 130 by generating its XML description. Once an agent is provided in this form, it can be re-instantiated either in a garage 130 or in a user's computer in an applet or a java application.

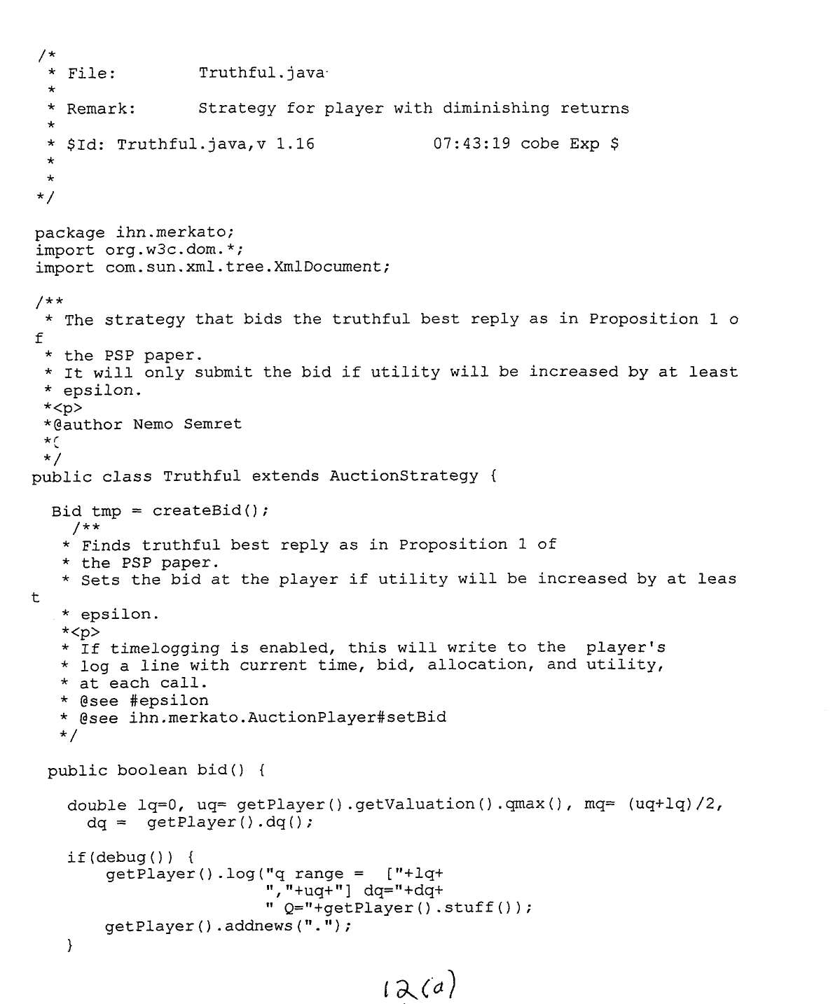

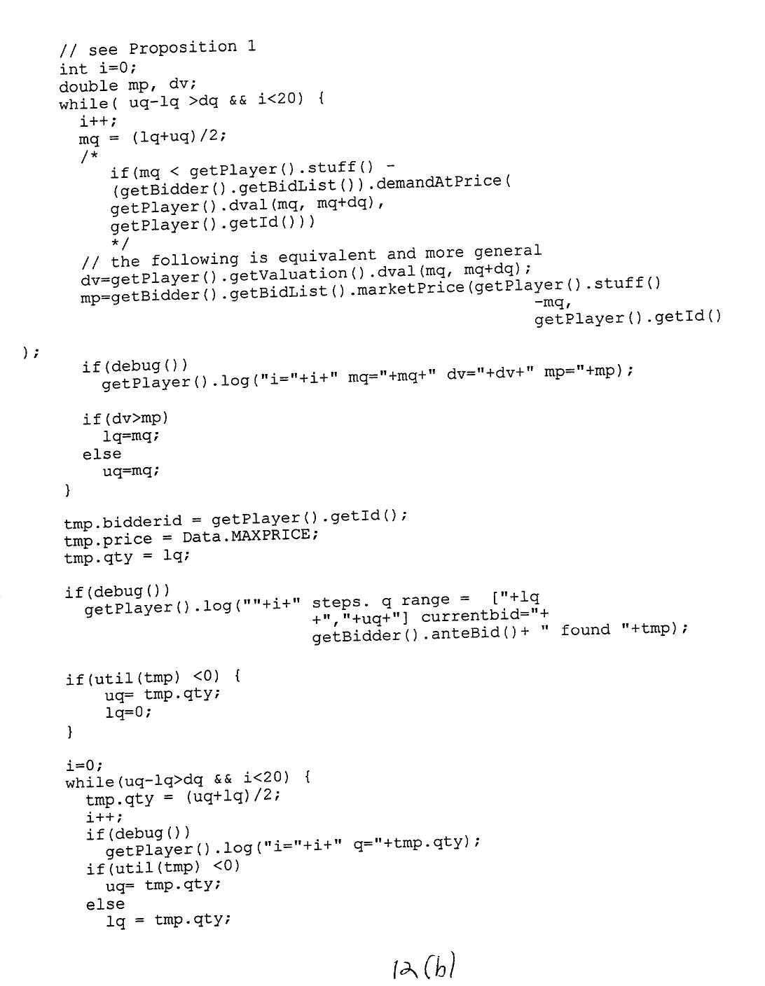

FIGS. 11(a)-11(b) are an example of an XML file for a generic player agent 102. This XML would be used, for example, to send the agent 102 to a client for execution in garage 930. Each of the XML tags (indicated by < > brackets) identifies an attribute of the agent that is to be activated in the garage. It will be understood that the XML of FIG. 11 is shown for purposes of example only and that other embodiments of the invention may use more or fewer tags and/or different tags than those shown in FIG. 11.

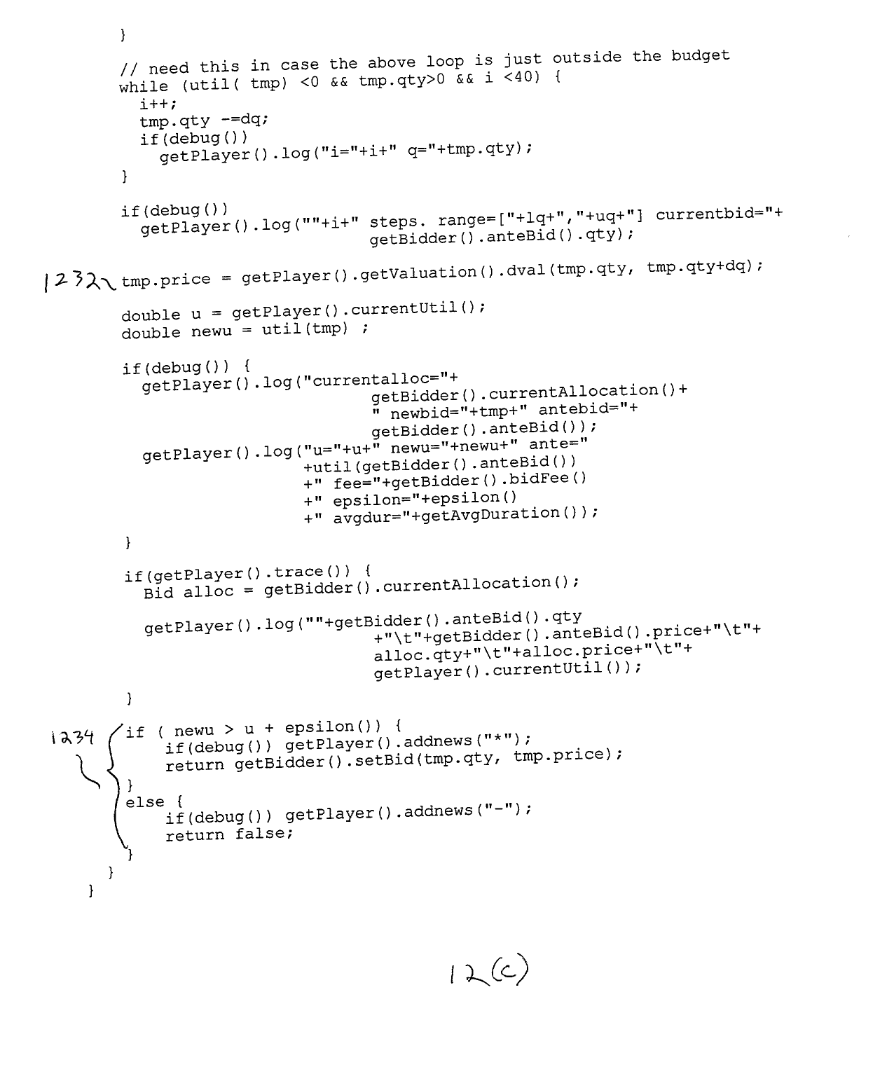

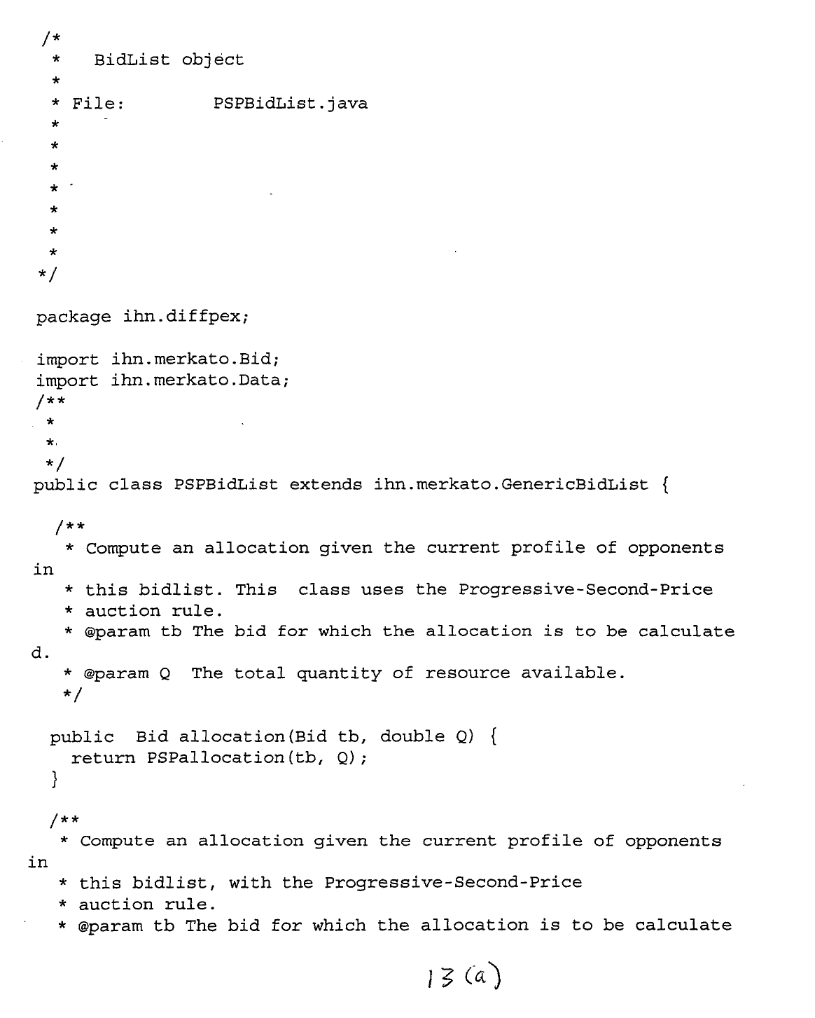

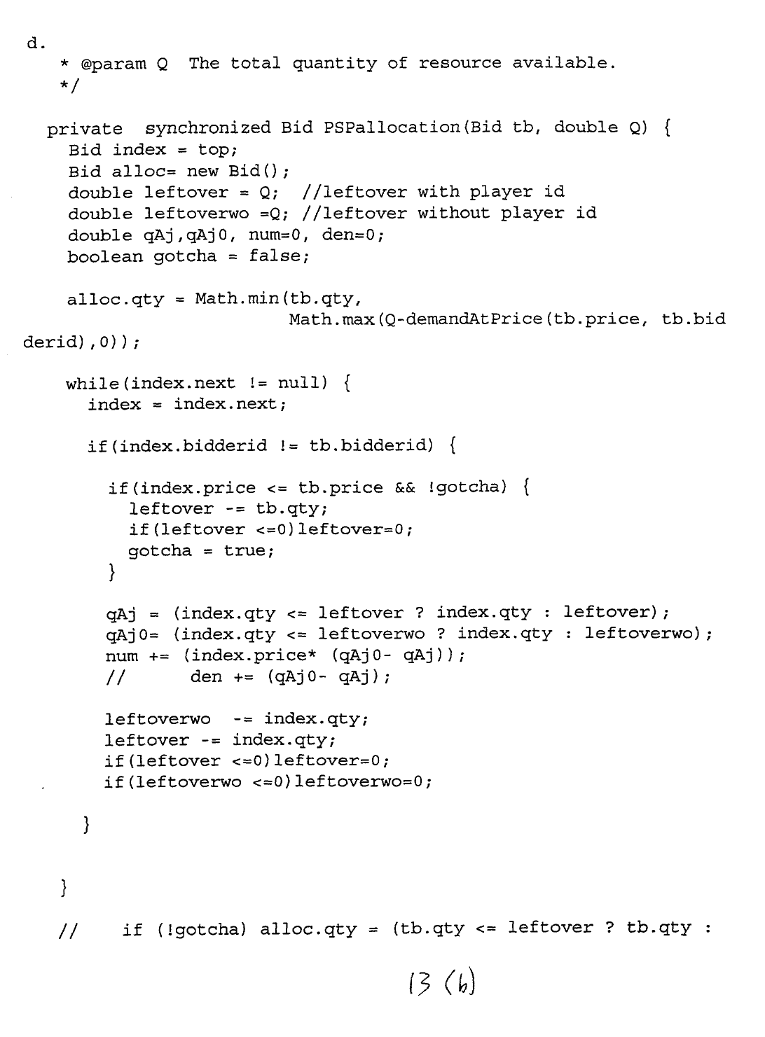

FIGS. 12(a)-12(c) shows an example of Java code implementing a strategy rule for a 102. This example implements a strategy in accordance with the PSP auction model described above. As shown in section 1234 of FIG. 12(c), an agent using this strategy will submit a new bid only if the new bid determined in the rule is increased by at least a calculated value epsilon. Note that this strategy rule calls a valuation rule in line 1232 of FIG. 12(c). This valuation rule implements a PSP valuation method.

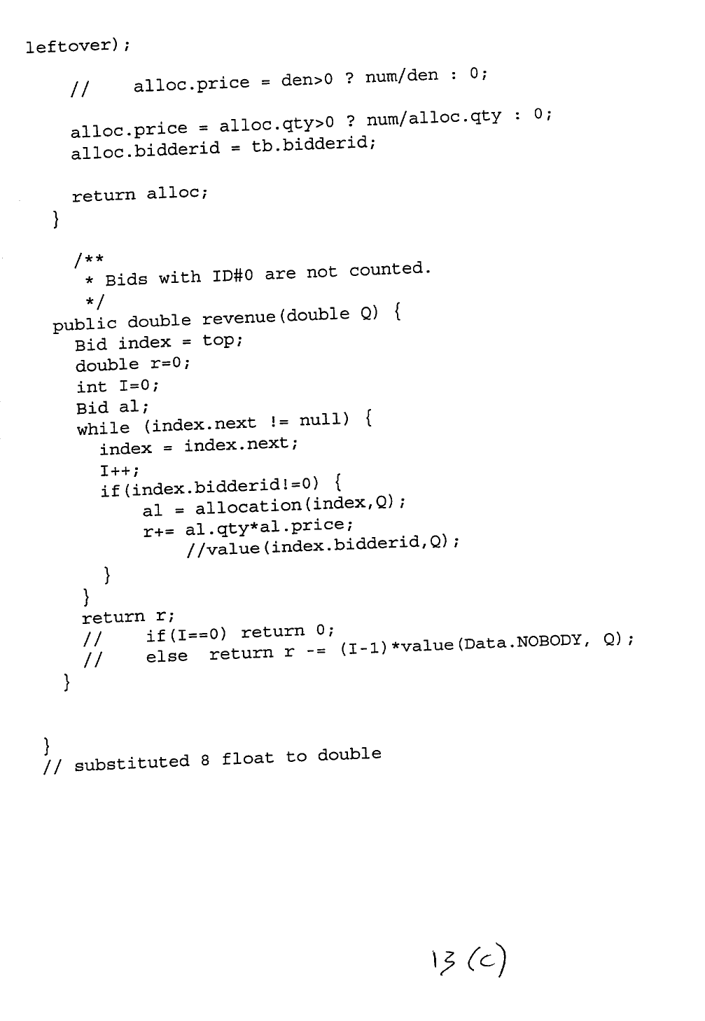

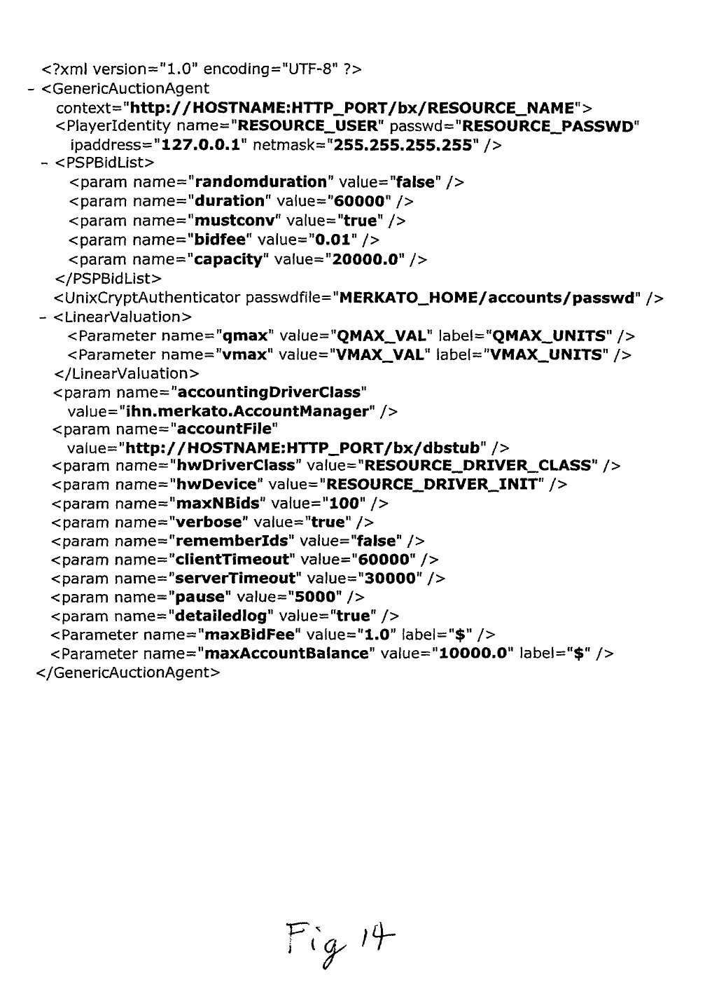

FIGS. 13(a)-13(c) show an example of Java code implementing an allocation rule for a resource agent 104. This example looks at a number of received bids in a bidlist data structure and computes an allocation (similar to that of FIG. 5) given the current bids on the bid list in accordance with a PSP auction allocation model.

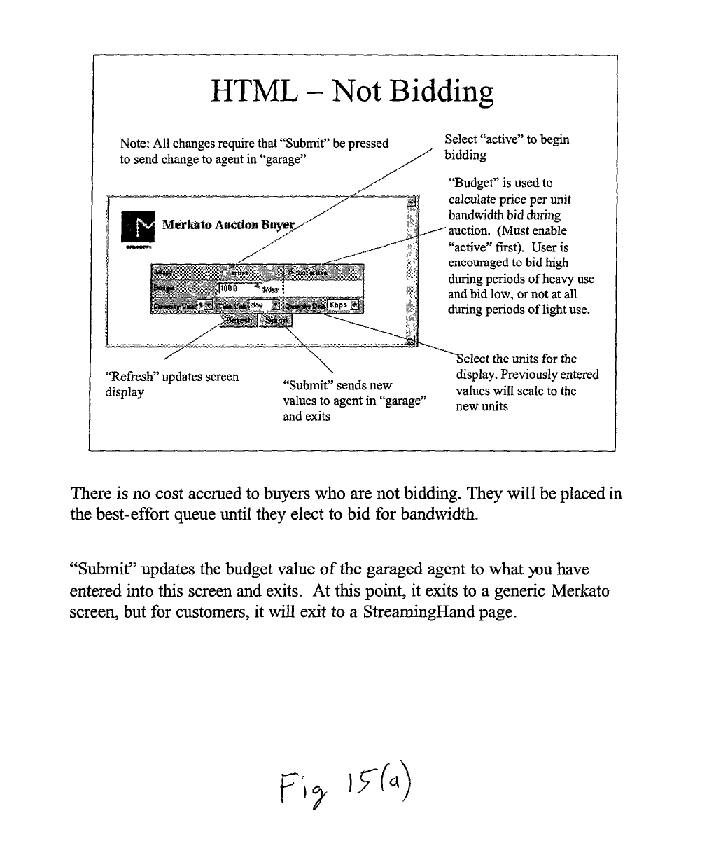

FIG. 14 is an example of an XML file for a generic resource agent 104. This XML would be used, for example, to send the resource agent 104 to a web server. Each of the XML tags (indicated by < > brackets) identifies an attribute of the agent that is to be activated on the server side.

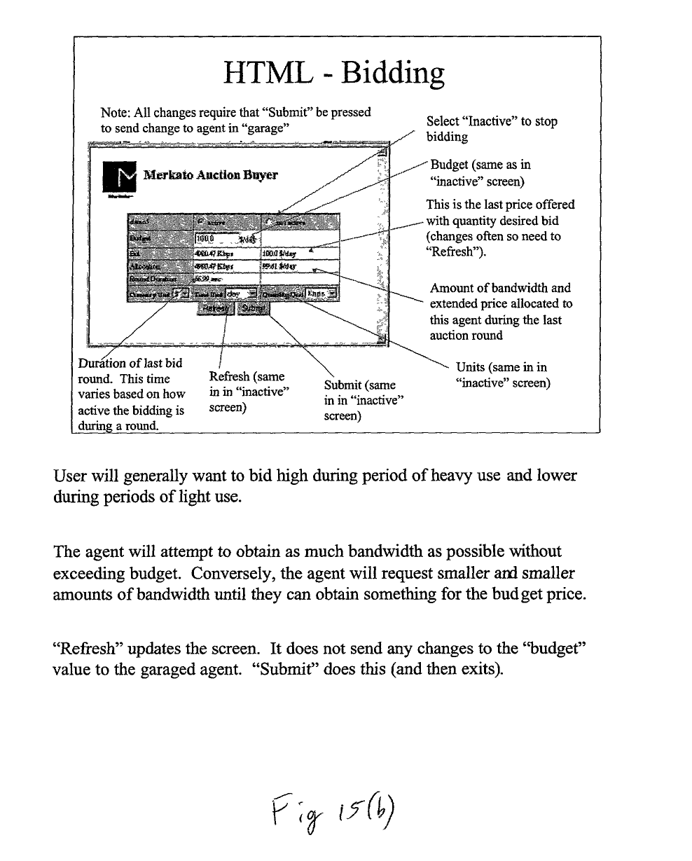

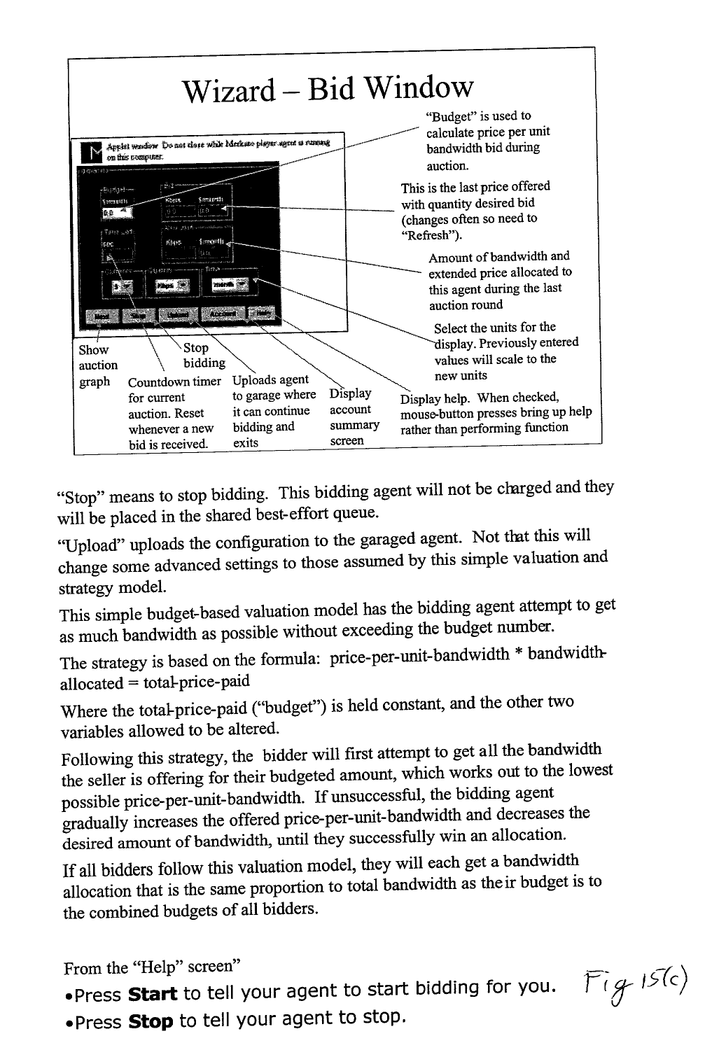

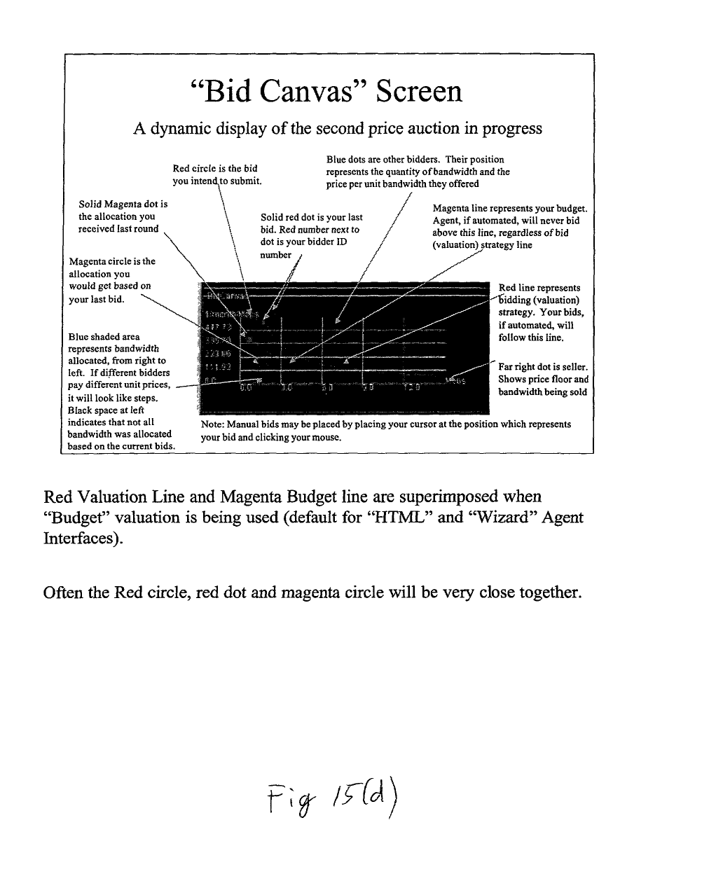

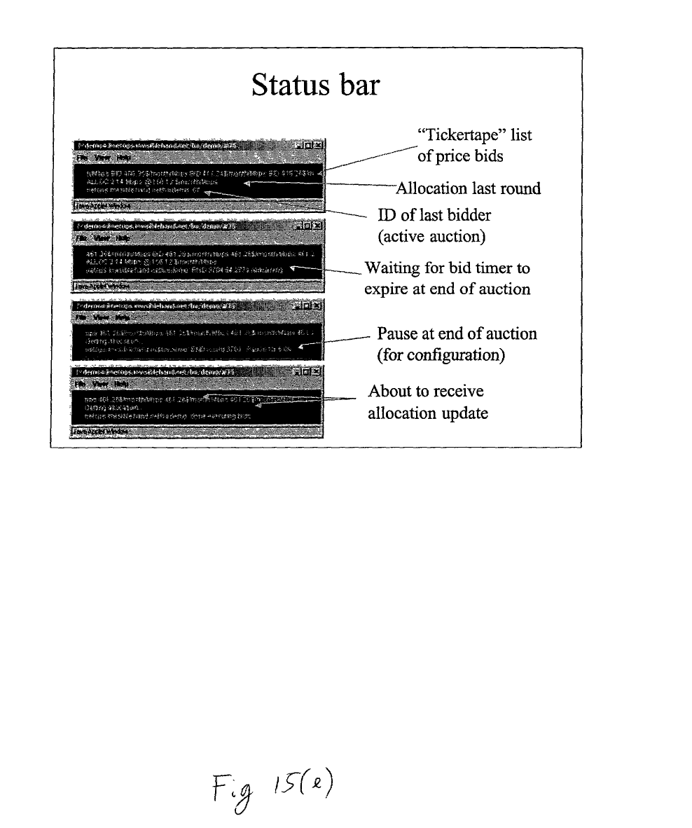

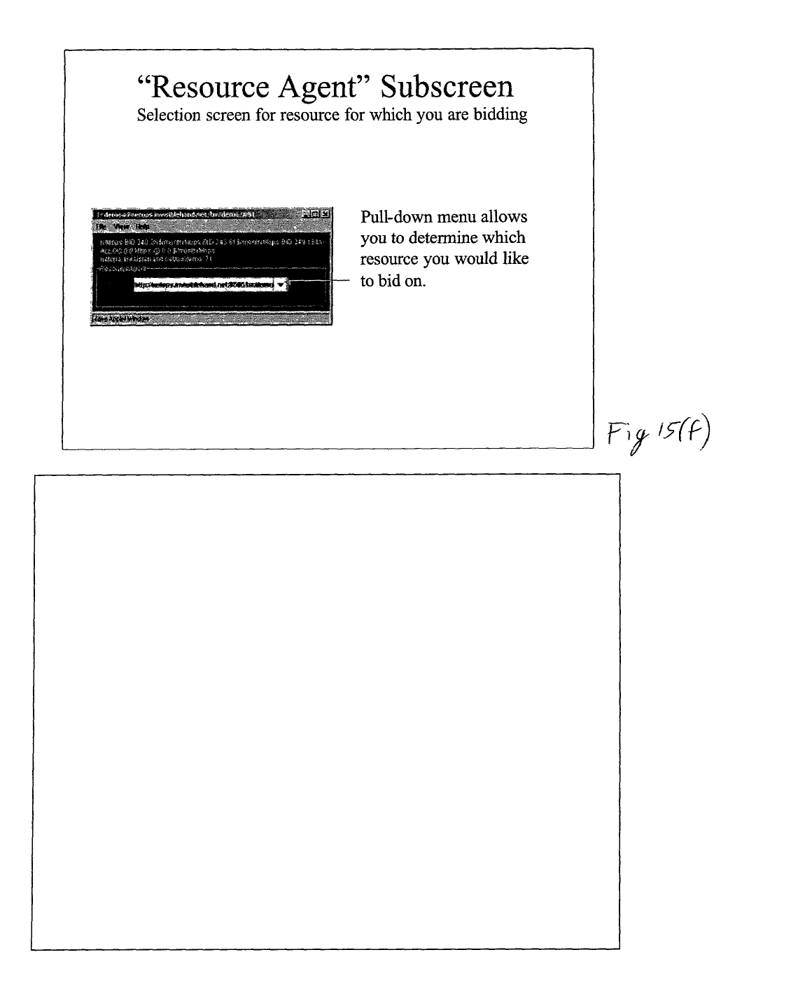

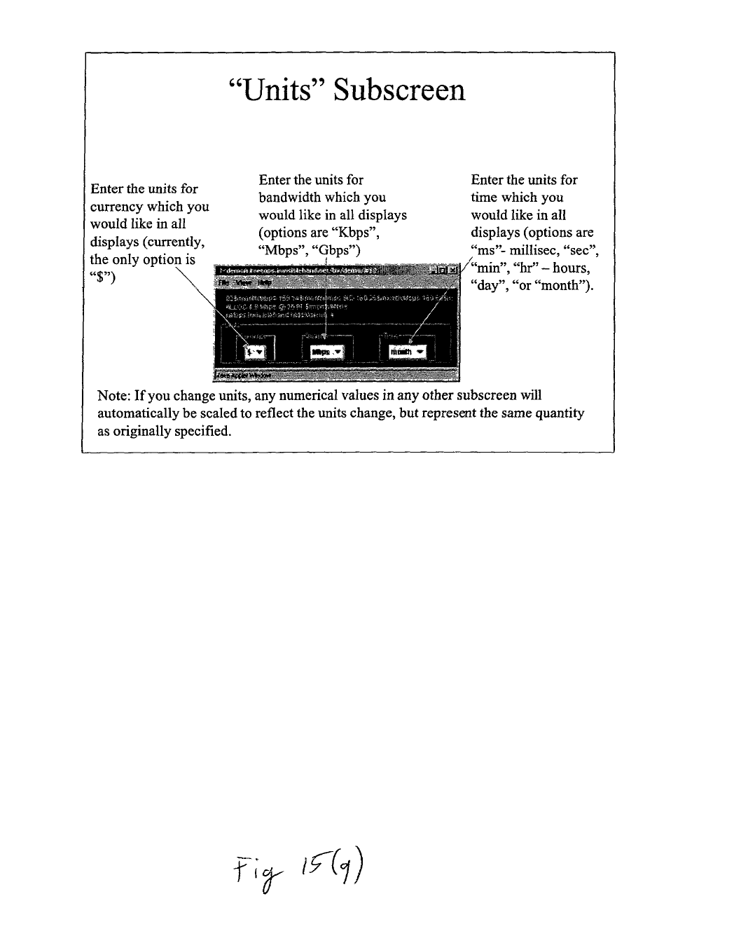

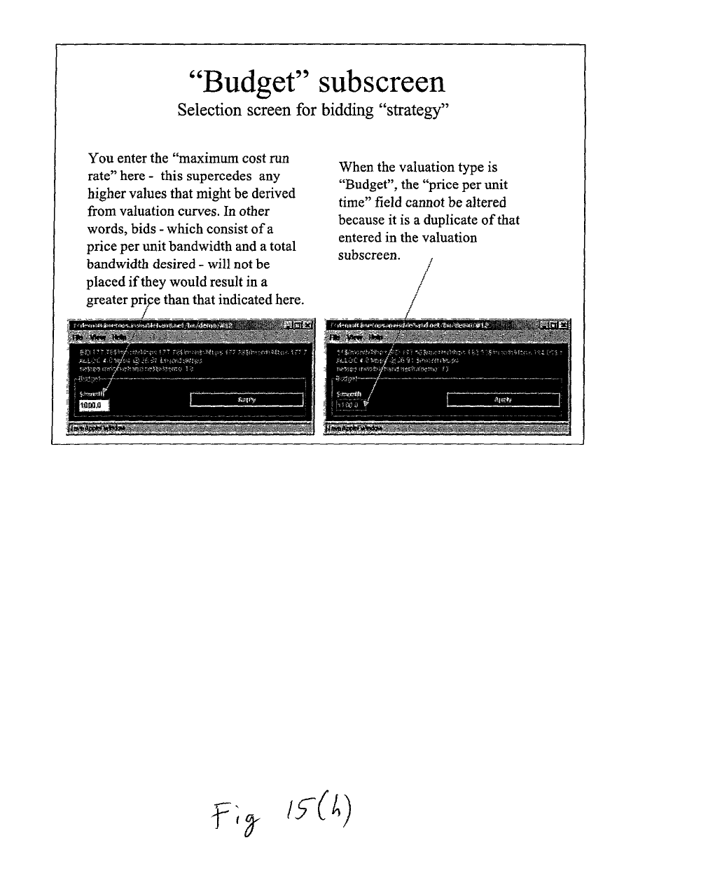

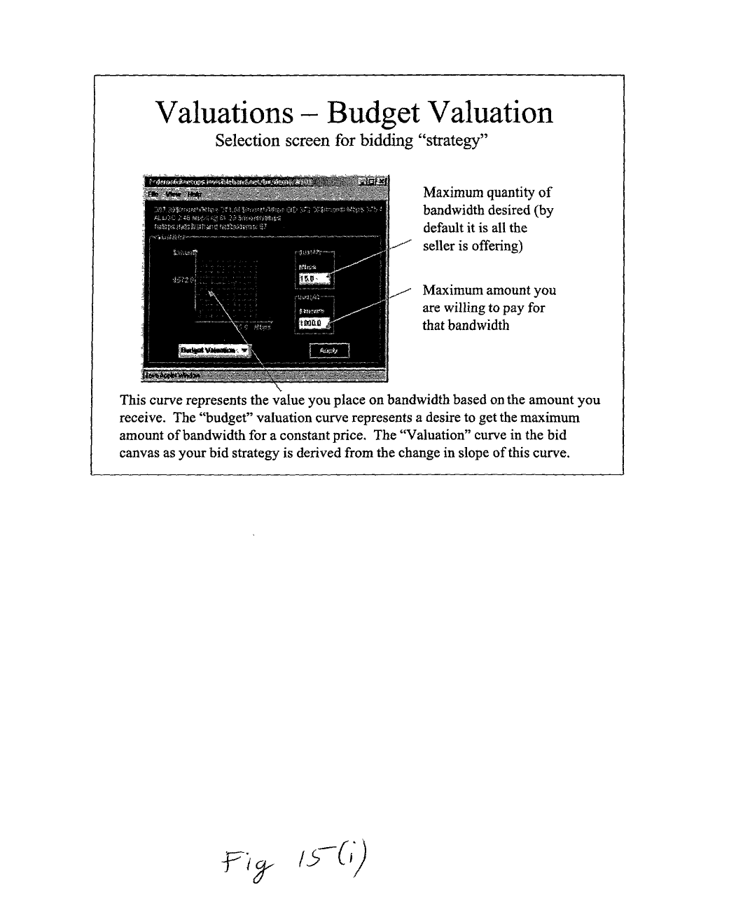

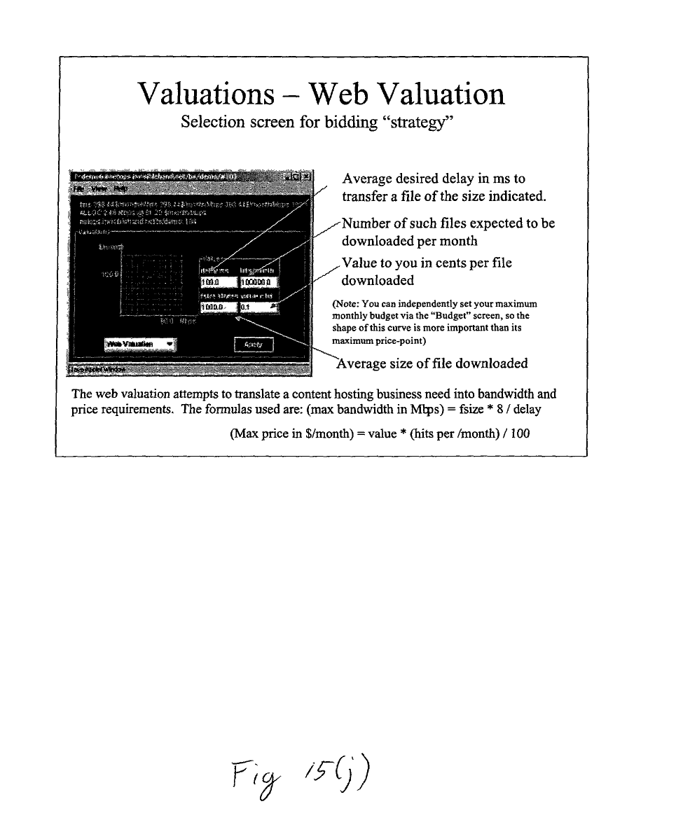

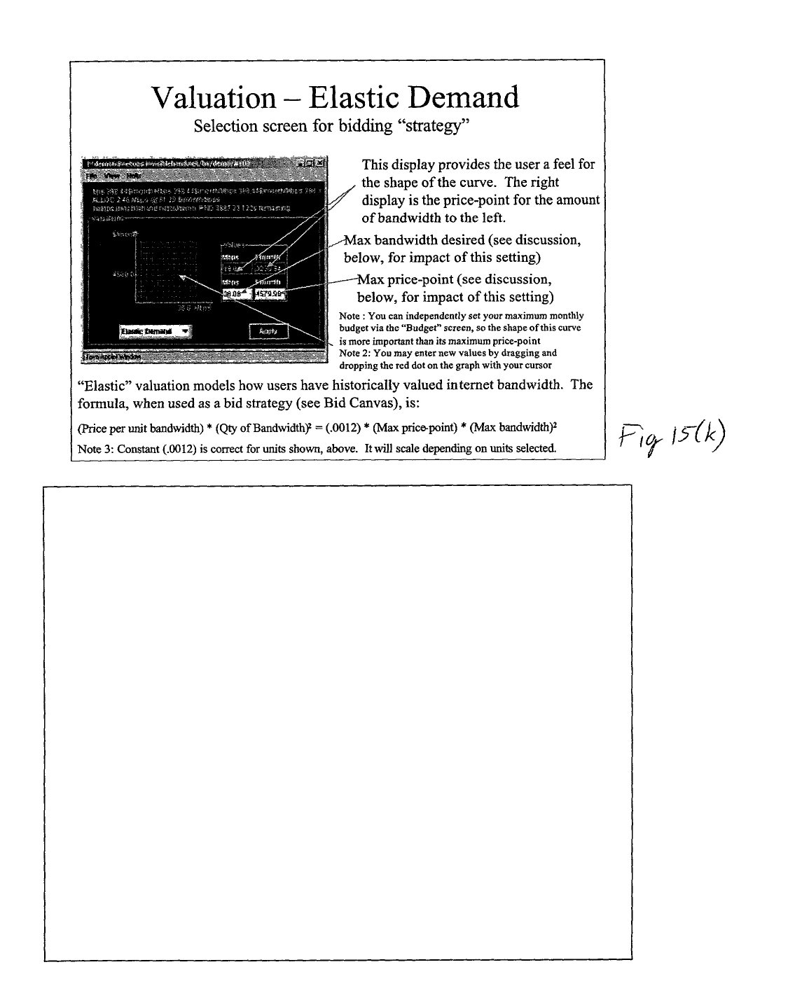

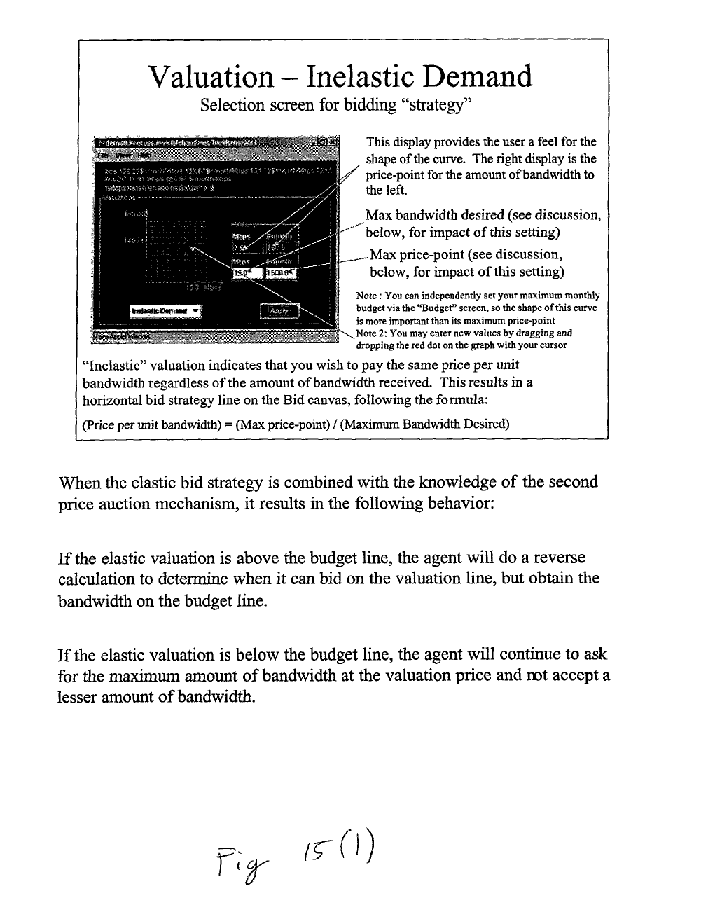

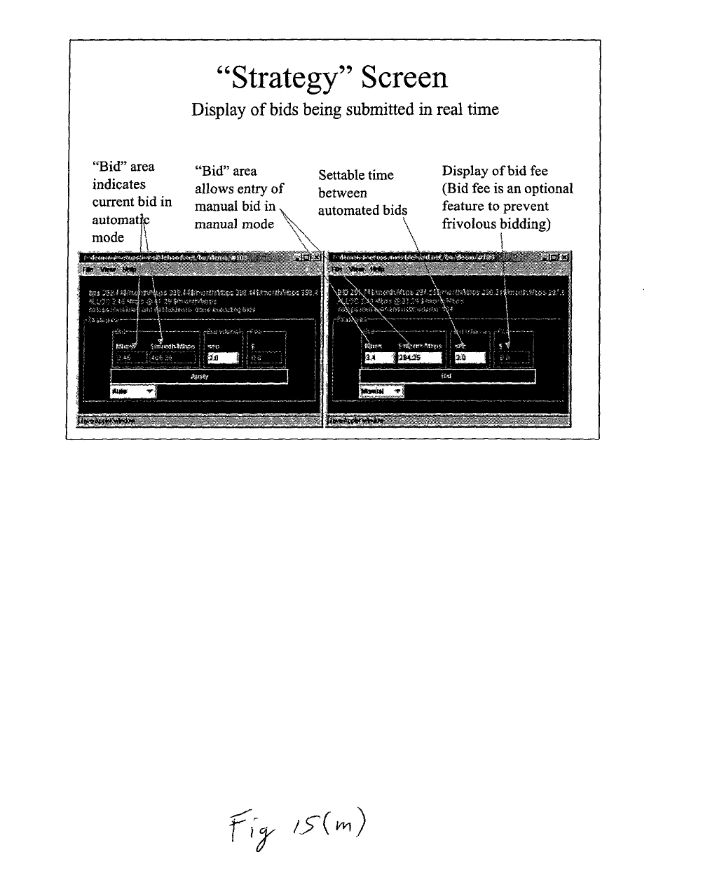

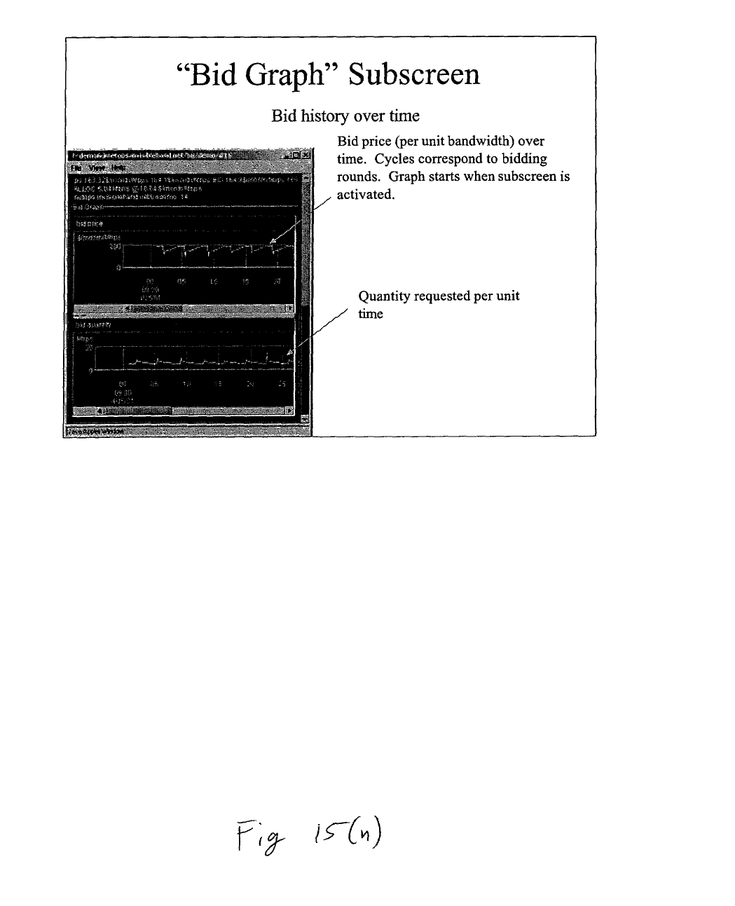

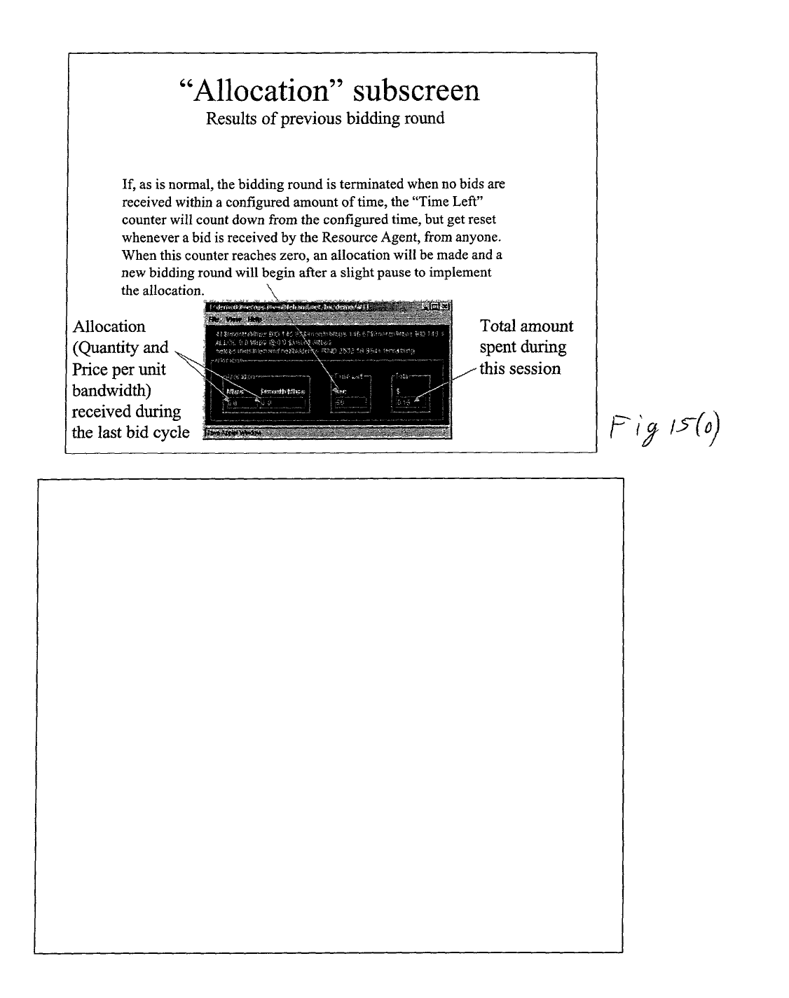

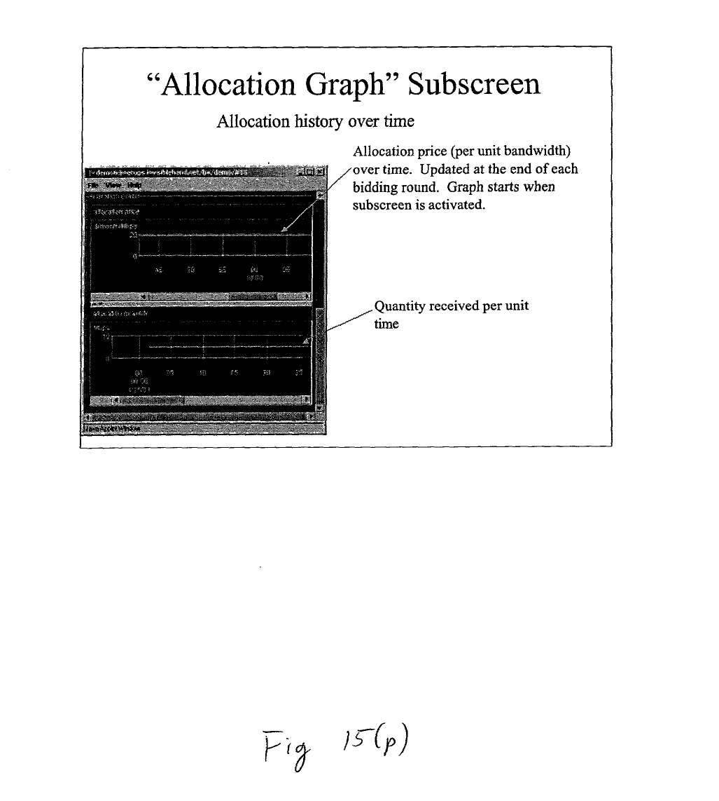

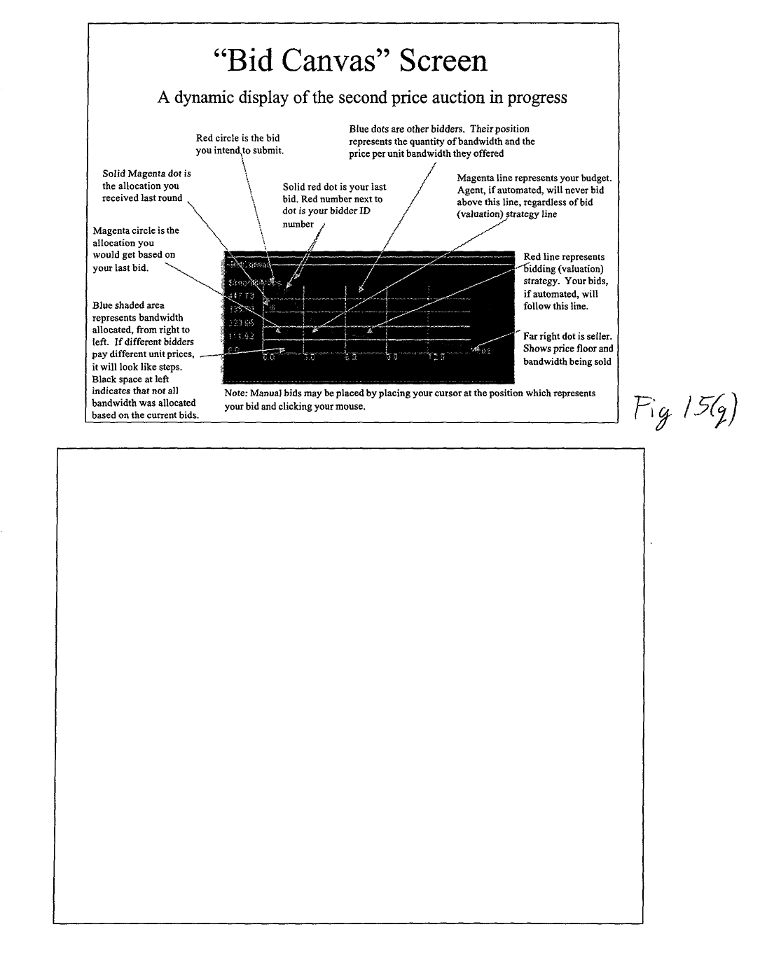

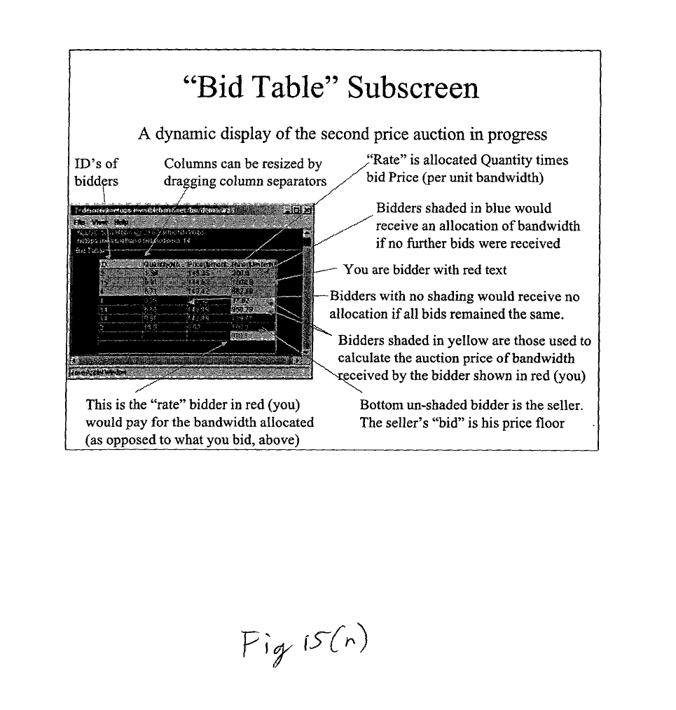

FIGS. 15(a)-15(r) show examples of user interfaces for buyer and seller agents. FIGS. 15(a) and 15(b) show an example of an html GUIs that provides static information to a user. FIGS. 15(c) and 15(d) show an example of GUIs implemented as a Java applet. The information provided by these interfaces is continuously updated in real-time or periodically. FIGS. 15(e)-15(r) show an example of an advanced GUI, which is preferably also implemented as an agent. Particular buyer and seller agents may have one, none, or all of the particular GUIs shown here, or may have GUIs providing other relevant information not shown here. Note that several of these GUIs allow a human user to choose the valuation and/or strategy rules and to determine when and how to bid. It should be understood that in the preferred embodiment, buyer agents are capable of bidding on their own. Other embodiments may contain agents that bid only at the direction human beings.

Accordingly, the present invention is intended to embrace all such alternatives, modifications and variations as fall within the spirit and scope of the appended claims and equivalents.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for real-time market-based resource allocation, comprising:
receiving at least one bid in real-time for a resource;
deciding which of the at least one bids has won the bidding; and
controlling the resource so that it is committed to the winning bidder.

2. The method of claim 1, wherein the resource is bandwidth.

3. The method of claim 1, wherein the resource is buffer space.

4. The method of claim 1, wherein the resource is processor time.

5. The method of claim 1, wherein the resource is controlled in real-time so that the winning bidder has access to the resource he has won as soon as bidding closes.

6. The method of claim 1, wherein the bid is received from a software agent.

7. The method of claim 6, wherein the software agent bids in accordance with a strategy rule.

8. The method of claim 7, wherein the strategy rule is a truthful best reply strategy.

9. The method of claim 6, wherein the software agent bids in accordance with a valuation rule.

10. The method of claim 9, wherein the valuation rule is determined in accordance with at least one measured network parameter.

11. The method of claim 6, wherein the software agent bids in accordance with an allocation rule.

12. The method of claim 1, wherein deciding which bid has won the bidding is performed in accordance with an allocation rule.

13. The method of claim 12, wherein deciding which bid has won the bidding is performed in accordance with a market allocation rule also used by a buyer software agent, the market allocation rule defining the rules of the resource market.

14. The method of claim 12, wherein deciding which bid has won the bidding is performed in accordance with an English Auction market allocation rule.

15. The method of claim 12, wherein deciding which bid has won the bidding is performed in accordance with a continuous bid-ask trading market allocation rule.

16. The method of claim 12, where deciding which bid has won the bidding is performed in accordance with a progressive second price auction allocation rule.

17. The method of claim 12, where deciding which bid has won the bidding is performed in accordance with a hold option allocation rule.

18. The method of claim 1, further comprising:
storing information concerning which bid has won, for accounting purposes.

19. The method of claim 1, wherein there are several resources, and a respective resource agent performs the elements of claim A for each resource.

20. The method of claim 1, wherein there is one resource, and a single resource agent performs the elements of claim 1 for the resource.

21. The method of claim 1, wherein the elements of claim 1 are performed by a resource agent executing on a separate computer than the placing the bids.

22. The method of claim 1, wherein the elements of claim 1 are performed by a resource agent executing on the same computer as at least one placing at least one of the bids.

23. The method of claim 1, wherein the is controlled by a human being, who decides how to bid.

24. The method of claim 1, further comprising:
deciding, by a bidder agent, how to bid based on a valuation function of the bidder agent and a strategy algorithm of the.

25. The method of claim 1, further comprising: receiving an offer to sell resources from a seller agent.

26. The method of claim 1, further comprising:
receiving player agents in a garage of a resource agent and receiving bids from player agents in the garage.

27. The method of claim 1, wherein the bid is received from a player agent that also submits offers to sell resources.

28. The method of claim 1, further comprising:
before bidding, receiving a request from a buyer software agent for a location of resource agent.

29. The method of claim 1, further comprising:
sending at least one bid in real-time for a resource;
receiving a notification that the sent bid has won the bidding;
selling the use of the winning resource to third parties through a separate resource agent; and
notifying a resource management and control agent that the third parties will be using the resource.

30. A method, performed by a multiagent, comprising:
sending at least one bid in real-time for a resource in accordance with a strategy rule and a valuation rule of the multiagent and in accordance with a system-wide allocation rule;
receiving a notification that the sent bid has won the bidding;
selling the use of the winning resource to third parties through a separate resource agent; and
notifying a resource management and control agent that the third parties will be using the resource.

31. A method, performed by a buyer agent, comprising:
sending at least one bid in real-time for a resource in accordance with a strategy rule and a valuation rule of the buyer agent and in accordance with a system-wide allocation rule;
receiving a notification that the sent bid has won the bidding; and
making use of the resource in real time, immediately after winning the bid.

32. The method of claim 32, wherein the system wide-allocation rule is a PSP allocation rule.

33. A system for real-time market-based resource allocation, comprising:
means for receiving at least one bid in real-time for a resource;
means for deciding which of the at least one bids has won the bidding; and
means for controlling the resource so that it is committed to the winning bidder.

34. A system for real-time market-based resource bidding by a multiagent, comprising:
means for sending at least one bid in real-time for a resource in accordance with a strategy rule and a valuation rule of the multiagent and in accordance with a system-wide allocation rule;
means for receiving a notification that the sent bid has won the bidding;
means for selling the use of the winning resource to third parties through a separate resource agent; and
means for notifying a resource management and control agent that the third parties will be using the resource.

35. A system for real-time market-based resource bidding by a buyer agent, comprising:
means for sending at least one bid in real-time for a resource in accordance with a strategy rule and a valuation rule of the buyer agent and in accordance with a system-wide allocation rule;
means for receiving a notification that the sent bid has won the bidding; and
means for making use of the resource in real time, immediately after winning the bid.

36. The system of claim 35, wherein the system wide-allocation rule is a PSP allocation rule.

37. A system for real-time market-based resource allocation, comprising:
a portion configured to receive at least one bid in real-time for a resource;
a portion configured to decide which of the at least one bids has won the bidding; and
a portion configured to control the resource so that it is committed to the winning bidder.

38. A system for real-time market-based resource bidding by a multiagent, comprising:
a portion configured to send at least one bid in real-time for a resource in accordance with a strategy rule and a valuation rule of the multiagent and in accordance with a system-wide allocation rule;
a portion configured to receive a notification that the sent bid has won the bidding;
a portion configured to sell the use of the winning resource to third parties through a separate resource agent; and
a portion configured to notify a resource management and control agent that the third parties will be using the resource.

39. A system for real-time market-based resource bidding by a buyer agent, comprising:
a portion configured to send at least one bid in real-time for a resource in accordance with a strategy rule and a valuation rule of the buyer agent and in accordance with a system-wide allocation rule;
a portion configured to receive a notification that the sent bid has won the bidding; and
a portion configured to make use of the resource in real time, immediately after winning the bid.

40. The system of claim 39, wherein the system wide-allocation rule is a PSP allocation rule.

41. A computer program product, including instructions for causing a data processing device to perform actions for real-time market-based resource allocation, comprising:
receiving at least one bid in real-time for a resource;
deciding which of the at least one bids has won the bidding; and
controlling the resource so that it is committed to the winning bidder.

42. A computer program product, including instructions for causing a multiagent of a data processing device to perform actions for real-time market-based resource bidding, comprising:
sending at least one bid in real-time for a resource in accordance with a strategy rule and a valuation rule of the multiagent and in accordance with a system-wide allocation rule;
receiving a notification that the sent bid has won the bidding;
selling the use of the winning resource to third parties through a separate resource agent; and
notifying a resource management and control agent that the third parties will be using the resource.

43. A computer program product, including instructions for causing a buyer agent of a data processing device to perform action for real-time market-based resource bidding, comprising:
sending at least one bid in real-time for a resource in accordance with a strategy rule and a valuation rule of the buyer agent and in accordance with a system-wide allocation rule;
receiving a notification that the sent bid has won the bidding; and
making use of the resource in real time, immediately after winning the bid.

44. The computer program product of claim 43, wherein the system wide-allocation rule is a PSP allocation rule.
